(19) United States
(12) Patent Application Publication
(10) Pub. No.: US 2014/0304046 A9
(43) Pub. Date: Oct. 9, 2014

(54) Universal Recognition Platform

(71) Applicant: One Inc., Toronto (CA)

(72) Inventors: Jeffrey Moscoe, Toronto (CA); Sacha Diab, Toronto (CA); Marc Lavine, Paris (FR); Michael Anthony Eubanks, Toronto (CA)

(73) Assignee: One Inc., Toronto (CA)

(21) Appl. No.: 13/905,202

(22) Filed: May 30, 2013

Related U.S. Application Data
(60) Provisional application No. 61/652,964, filed on May 30, 2012.

(51) Int. Cl. G06Q 30/02

(52) U.S. Cl. CPC G06Q 30/0229
USPC 705/14.3

(57) ABSTRACT

A platform for universal recognition (UR) is described. A consumer has one or more UR numbers, each of which is uniquely recognizable within the UR platform. During a transaction with a merchant, the consumer uses a non-payment token that presents a UR number or uses a payment token that presents a payment number associated with a UR number. A membership identifier used to recognize the consumer within a membership program of the merchant is retrieved and routed to the merchant. Each UR number begins with a six-digit Issuer Identification Number (IIN) which identifies the UR platform from which the UR number was issued.

### TECHNICAL FIELD

The following relates generally to a platform for membership recognition, and particularly to a platform for universal recognition of one or more memberships using a universal recognition number.

### BACKGROUND

In order to make use of a membership in an organization or a membership in a merchant's loyalty program, a consumer typically needs to carry a token presenting the required membership identifier at the site of the organization or merchant. With the growing number of loyalty programs and organizations of which a consumer may become a member, it may be difficult for the consumer to make use of all of his/her memberships. For example, where each membership identifier is presented via a different token, the consumer must remember to carry all of the required tokens in order to benefit or gain access from membership in the various organizations and from membership in the various loyalty programs. This is burdensome and has been shown to result in lower use of and lower enrollment in memberships and loyalty programs.

### SUMMARY

The technology described herein provides a platform for universal recognition (UR). The UR platform is an open platform (i.e. stakeholder and technology agnostic) having a collection of capabilities and applications serving an eco-system. Various hardware and software elements (for example, servers, networks, firewalls, routers, database) implement the UR platform. The capabilities may include, for example, real-time data message switching/routing, identifier acceptance/issuance, mobile-contactless services, reporting, authentication, security and encryption. Applications offered by the UR platform, such as linking, matching, and enrolling, enable recognition at any and every point of presentation via an industry standard unique identifier. These capabilities and applications may provide services (for example, recognition, real-time offers, points management, points issuance, points balances, redemption, currency balance, data modeling and analysis) to businesses and organizations. The eco-system is comprised of the provider of the UR platform, participating merchants, consumers wishing to be recognized by the participating merchants, any third-party operators of membership systems affiliated with some of the participating merchants, and multiple payment transaction partners (acquirers and/or payment processors and/or issuers). The UR platform leverages existing industry standards and existing technology and communication infrastructure to reduce the number of technology modifications needed to implement and participate within the UR platform.

As part of the UR platform, the provider employs a universal recognition and routing (URR) system, which recognizes a UR number that has been issued to a consumer and activated by the consumer. In response to receiving the UR number and an indication of a membership program for which a membership identifier is needed, the URR system may retrieve the appropriate membership identifier that is linked to the UR number and that corresponds to the indicated membership program. Each UR number is unique within the UR platform and is uniquely recognizable by the URR system.

Each UR number begins with a six-digit Issuer Identification Number (IIN) which identifies the UR platform from which the UR number was issued. In one example, the IIN is 636831, which was assigned to One Inc. (a Canadian corporation located in Toronto, Ontario, Canada) by the Canadian Standards Council (CSC) and the International Standards Organization (ISO). In future, One Inc. may be assigned or adopt additional IINs that also identify the UR platform. A UR platform operated by an entity other than One Inc. may have a different IIN than 636831.

Following the six-digit IIN, the UR number includes additional digits, for example, between ten and fifteen additional digits. In one example, the UR number has nineteen digits, where the six-digit IIN is followed by twelve digits representing an individual account identifier number, and the final digit is a check digit. In another example, the UR number has sixteen digits, where the six-digit IIN is followed by nine digits representing an individual account number, and the final digit is a check digit.

A consumer is considered to have joined the UR platform once there exists within the UR platform a UR account that is connected with the consumer. A UR account includes one or more UR numbers that have been issued to the consumer, and one or more items of consumer identity information, such as name, mailing address, telephone number, email address, and the like.

Each UR number may be linked to one or more membership identifiers, where a membership identifier may be uniquely recognizable by a merchant's membership program. For example, the URR system may include a UR database, and a UR number recorded in the UR database may be linked to at least one membership identifier that is recognized by a membership program. Once this linkage has occurred the consumer's account will be considered activated in the UR platform.

A merchant that participates in the UR platform's eco-system may update an IIN range table at or accessible by each of its point-of-sale devices such that, when a transaction occurs in which a UR number is presented at a point-of-sale device, the point-of-sale device directs communications for that transaction over a network to the URR system. That is, when a token capture device at the point-of-sale device captures from a non-payment token a number starting with the six-digit IIN identifying the UR platform (e.g. the six-digit IIN 636831 identifying a UR platform provided by One Inc.), the point-of-sale device sends to the URR system the UR number and an indication of the membership program for which a membership identifier is needed. This indication may be in the form of a merchant identifier.

When the URR system receives the UR number and the merchant identifier, the URR system may locate the UR number in the UR database, retrieve the linked membership identifier for the merchant's membership program, and send the membership identifier to an entity that has been agreed upon by the UR platform provider and the merchant. For example, the membership identifier may be sent to the merchant or to the merchant's membership system or to a third party membership system affiliated with the merchant. Accordingly, instead of receiving the membership identifier directly from the token presented at the token capture device of the point-of-sale device, the entity receives the membership identifier from the URR system. Importantly, the membership identifier is used by the entity to recognize the consumer within the membership program in connection with the transaction, despite the consumer not having provided during the transaction any token that presents the membership identifier.

Where two or more different merchants, each having a different membership program, participate in the UR platform's eco-system, a consumer that is a member of the different membership programs may be recognized by each membership program using a single token presenting a single UR number. The principal change needed in the traditional operation of the merchant is the updating of the merchant's IIN range table at or accessible by each point-of-sale device so that the point-of-sale device directs communications associated with UR numbers to the URR system.

The UR number may serve as a membership identifier for a particular merchant's membership program. In one implementation, the UR platform provider may allocate a pool of UR numbers (for example, all numbers between 636831 55555 0000 C and 636831 55555 9999 C, where C is the check digit calculated from the preceding digits) to a merchant. The merchant can then use a UR number from the allocated pool as the membership identifier for a consumer when the consumer joins its membership program, and can provide a token having that UR number to the consumer. In another implementation, the merchant can request that the UR platform generates one UR number or a batch of UR numbers on demand, and then use the generated UR number as the membership identifier for a consumer when the consumer joins its membership program, and can provide a token having that UR number to the consumer. In that implementation, the UR platform may generate any UR numbers for the merchant, or may generate UR numbers that meet specific numbering requirements of the merchant. A UR number serving as a membership identifier for a particular membership program may be considered inactive until the membership has been activated by the consumer.

When using a payment token, such as a credit card or a debit card or a prepaid card, payment is typically handled by an acquirer data centre, a payment processor data centre, and an issuer data centre. The acquirer screens and accepts merchants into its program. The acquirer data centre processes financial transactions and completes financial settlements. Examples of acquirers include Moneris Solutions, Inc. and Chase Paymentech Solutions, LLC. The payment processor provides its brand to member financial institutions that in turn provide services to consumers and merchants. Examples of payment processors include Visa Inc. (providing the brand VISA®), MasterCard International Incorporated (providing the brand MasterCard®), and Discover Financial Services (providing the brand Discover®). The issuer is a financial institution of the consumer. Examples of issuers include banks, credit unions, and savings and loans. American Express Company (providing the brand American Express®) is a payment processor and its own issuer.

As with a typical financial transaction, a consumer presents a payment token at a point-of-sale device of a merchant. A token capture device captures a payment number from the payment token, and the point-of-sale device sends to the acquirer data centre the payment number, a merchant identifier, and additional information concerning the financial transaction. The acquirer data centre, the payment processor data centre and the issuer data centre then process the financial transaction in the traditional manner. Examples of a payment number include a credit card number, a charge card number, a debit card number, and a prepaid card number.

In accordance with the technology disclosed herein, a UR number may be associated with a payment number. The UR platform provider may allocate a pool of UR numbers (for example, all UR numbers between 636831 34 0000000 C and 636831 34 99999999 C, where C is the check digit calculated from the preceding digits) to a payment transaction partner that has partnered with the UR platform provider. Payment transaction partners may be payment processors or issuers or acquirers. UR numbers from the allocated pool may be associated by the payment transaction partner to payment numbers. A UR number associated by the payment transaction partner to a payment number may be considered inactive until the payment number itself has been activated by the consumer.

In accordance with the technology disclosed herein, a table of payment numbers and associated UR numbers is maintained by each payment transaction partner data centre, where each payment number in the table is associated with a single UR number in the table. Logic and commands are implemented at the payment transaction partner data centre, so that responsive to receiving a payment number as part of a financial transaction at a merchant, the payment transaction partner data centre may, in the event that the payment number is listed in the table, retrieve the associated UR number from the table and may send the retrieved UR number to the URR system, together with the merchant identifier.

As described previously with respect to the non-payment token example, when the URR system receives the UR number and the merchant identifier, the URR system may locate the UR number in the UR database, retrieve the linked membership identifier for the merchant's membership program, and send the membership identifier to an entity that has been agreed upon by the UR platform provider and the merchant. Accordingly, instead of receiving the membership identifier directly from the token presented at the token capture device of the point-of-sale device, the entity receives the membership identifier from the URR system. Importantly, the membership identifier is used by the entity to recognize the consumer within the membership program in connection with the financial transaction, despite the consumer not having provided during the financial transaction any token that presents the membership identifier.

Where two or more different merchants, each having a different membership program, participate in the UR platform's eco-system, a consumer that is a member of the different membership programs may be recognized by each membership program using a single payment token presenting a payment number that is associated with a UR number. Where a merchant having a membership program participates in the UR platform's eco-system, a consumer that is a member of the membership program may be recognized by the membership program using different payment tokens presenting different payment numbers that are associated with different UR numbers. The principal change needed in the traditional operation of each payment transaction partner data centre is the maintenance of the table of payment numbers and associated UR numbers and the implementation of the aforementioned logic and commands, so that the payment transaction partner data centre is able to retrieve a UR number associated with a payment number, and send the retrieved UR number to the URR system.

Payment transaction partners may choose to provide the URR system only with UR numbers, merchant identifiers and information needed to reconcile a transaction. Importantly, in most implementations described in this document, no payment numbers are shared with the URR system. Thus, the confidentiality of a consumer's payment number along the communication path between the merchant and the issuer data centre is not affected by the technology described herein. However, in other implementations, payment numbers may indeed be shared with the URR system.

Furthermore, information about membership programs and consumers' membership accounts may not be shared with the UR platform. Thus, the confidentiality of merchants' membership programs and consumers' membership accounts in those programs is not impacted by the technology described herein. As in a traditional transaction involving membership recognition, the merchant or the membership system affiliated with the merchant may be fully responsible for handling a consumer's membership account.

### BRIEF DESCRIPTION OF THE DRAWINGS AND APPENDICES

FIG. 1 illustrates a schematic diagram of two example transactions at two different merchants, the transactions both involving the same non-payment token presenting the same universal recognition number;

FIG. 2-1 illustrates a schematic diagram of two example transactions at two different merchants, the transactions both involving the same payment token presenting the same payment number associated with the same universal recognition number, where retrieval and routing of the universal recognition number that is associated with the payment number is performed by a payment processor data centre;

FIG. 2-2 illustrates a schematic diagram of two example transactions at two different merchants, the transactions both involving the same payment token presenting the same payment number associated with the same universal recognition number, where retrieval and routing of the universal recognition number that is associated with the payment number is performed by an issuer data centre;

FIG. 2-3 illustrates a schematic diagram of two example transactions at two different merchants, the first of the transactions involving a first payment token presenting a first payment number associated with a first universal recognition number, and the second of the transactions involving a second payment token presenting a second payment number associated with a second universal recognition number, where both the first payment token and the second payment token are possessed by the same consumer;

FIG. 2-4 illustrates another schematic diagram of two example transactions at two different merchants, the first of the transactions involving a first payment token presenting a first payment number associated with a first universal recognition number, and the second of the transactions involving a second payment token presenting a second payment number associated with a second universal recognition number, where both the first payment token and the second payment token are possessed by the same consumer;

FIG. 2-5 illustrates another schematic diagram of two example transactions at two different merchants, where both merchants are affiliated with a third-party membership program, and the consumer is a member of that third-party membership program;

FIG. 3 illustrates a conceptual diagram of an example universal recognition account of a consumer;

FIG. 4 illustrates example methods for a consumer, for a merchant, and for a universal recognition and routing (URR) system, where the methods are for use with a non-payment token presenting a universal recognition number that is linked to a membership identifier of the merchant's membership program;

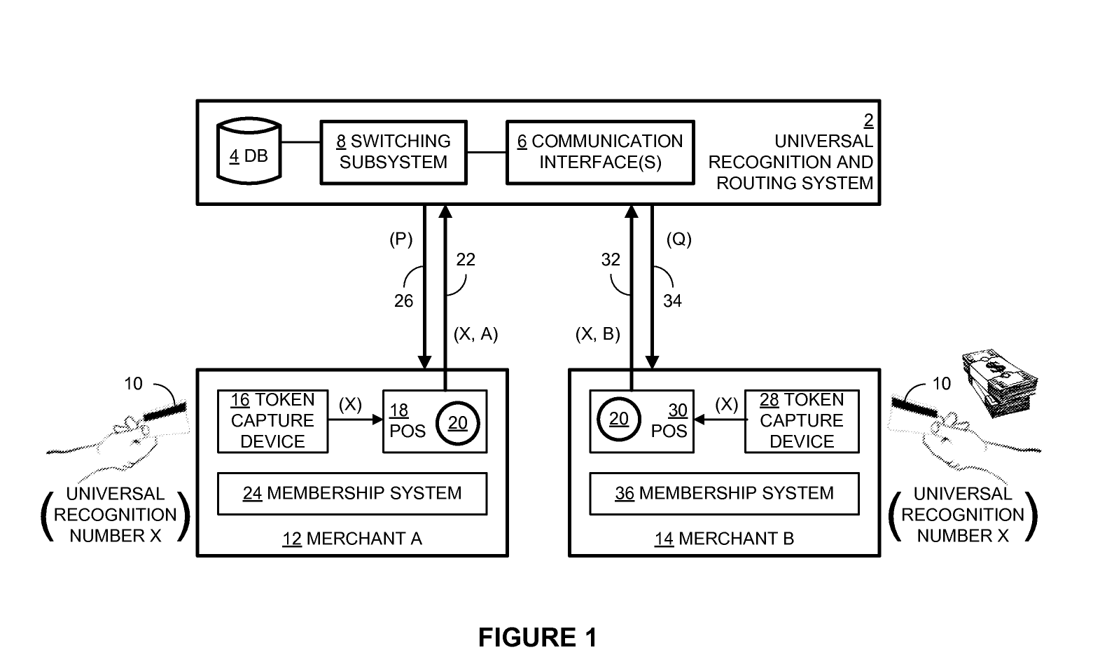

The combination of FIGS. 5-1 and 5-4 illustrates example methods for a consumer, for a merchant, for an acquirer data centre, for a payment processor data centre, for an issuer data centre and for a universal recognition and routing system, where the methods are for use with a payment token presenting a payment number associated with a universal recognition number that is linked to a membership identifier of a merchant's membership program, and where retrieval and routing of the universal recognition number is performed by the payment processor data centre;

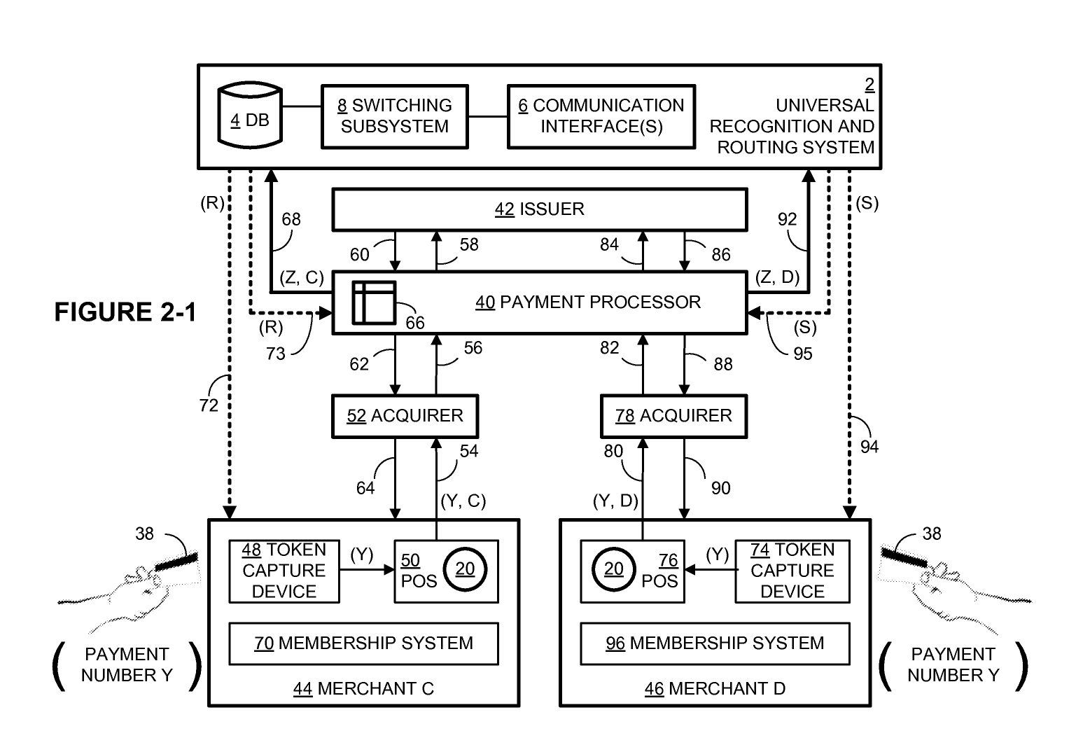

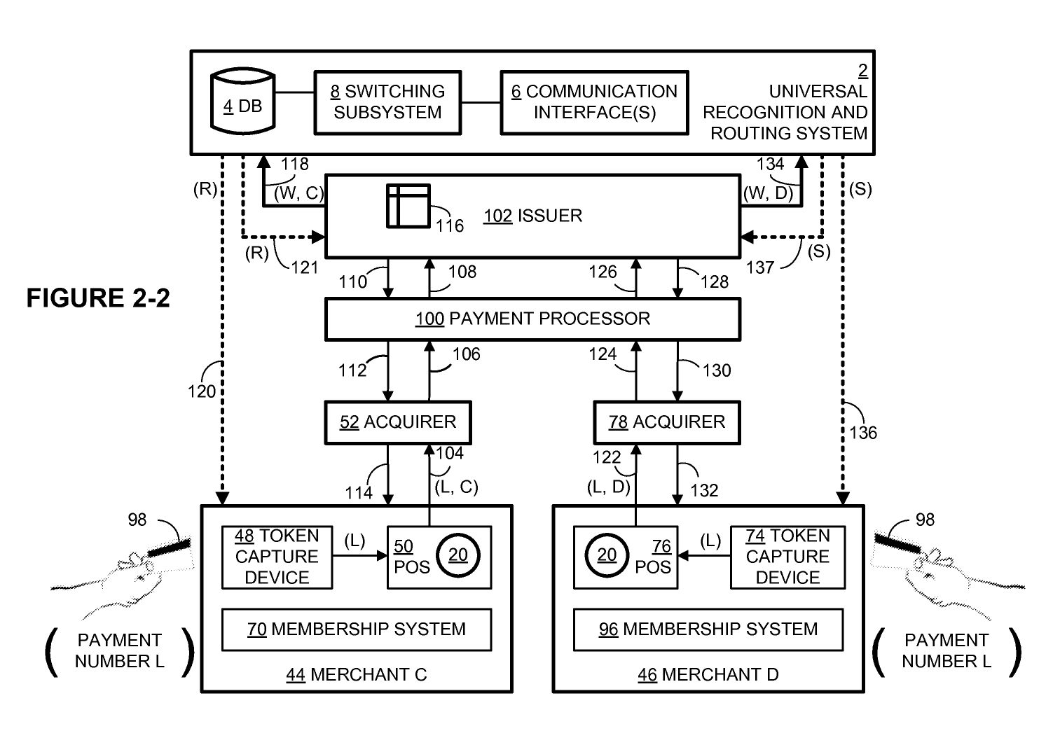

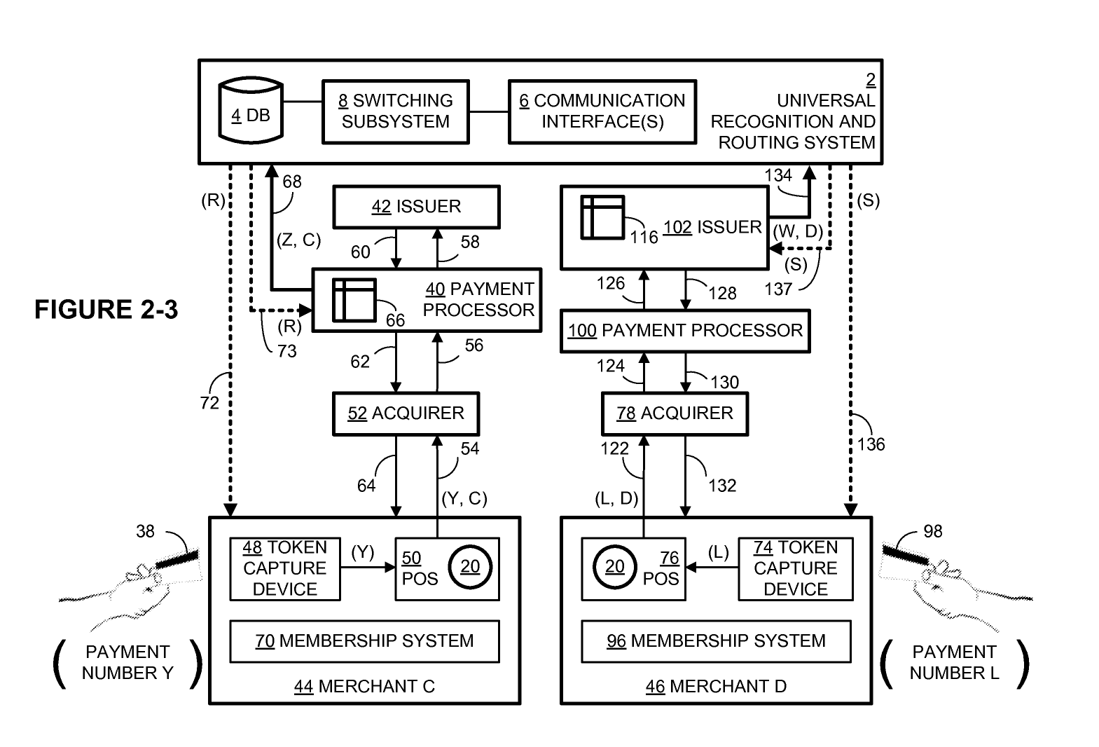

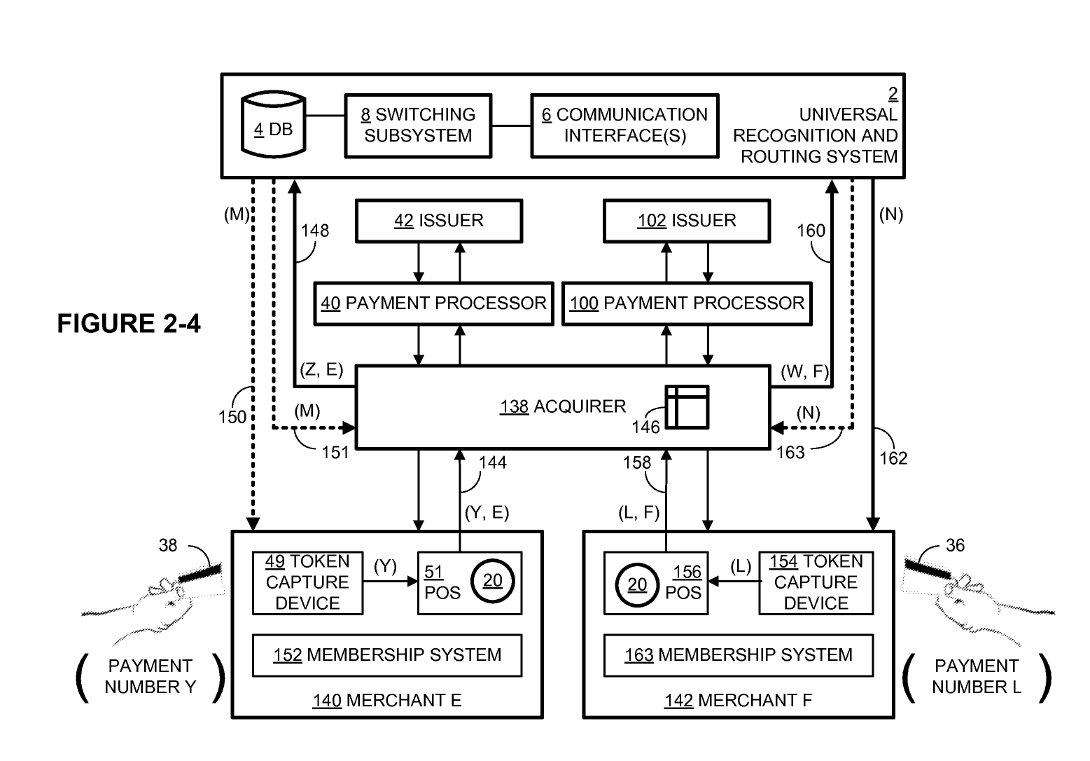

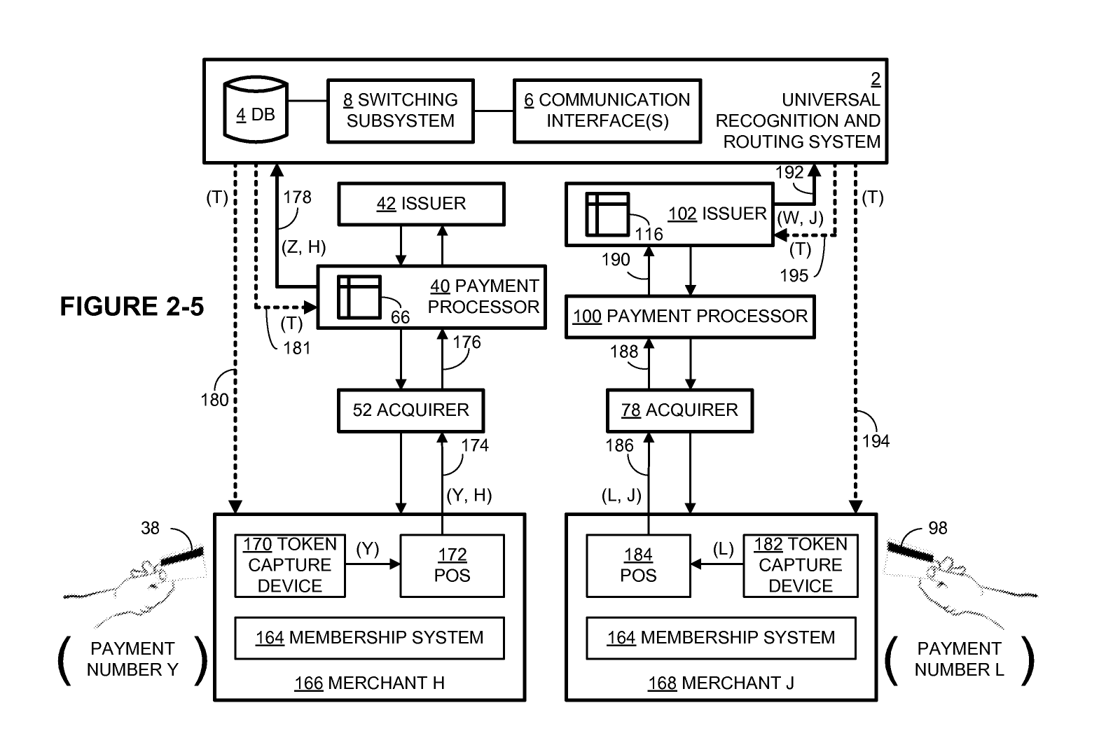

The combination of FIGS. 5-2 and 5-4 illustrates example methods for a consumer, for a merchant, for an acquirer data centre, for a payment processor data centre, for an issuer data centre and for a universal recognition and routing system, where the methods are for use with a payment token presenting a payment number associated with a universal recognition number that is linked to a membership identifier of the merchant's membership program, and where retrieval and routing of the universal recognition number is performed by the acquirer data centre;

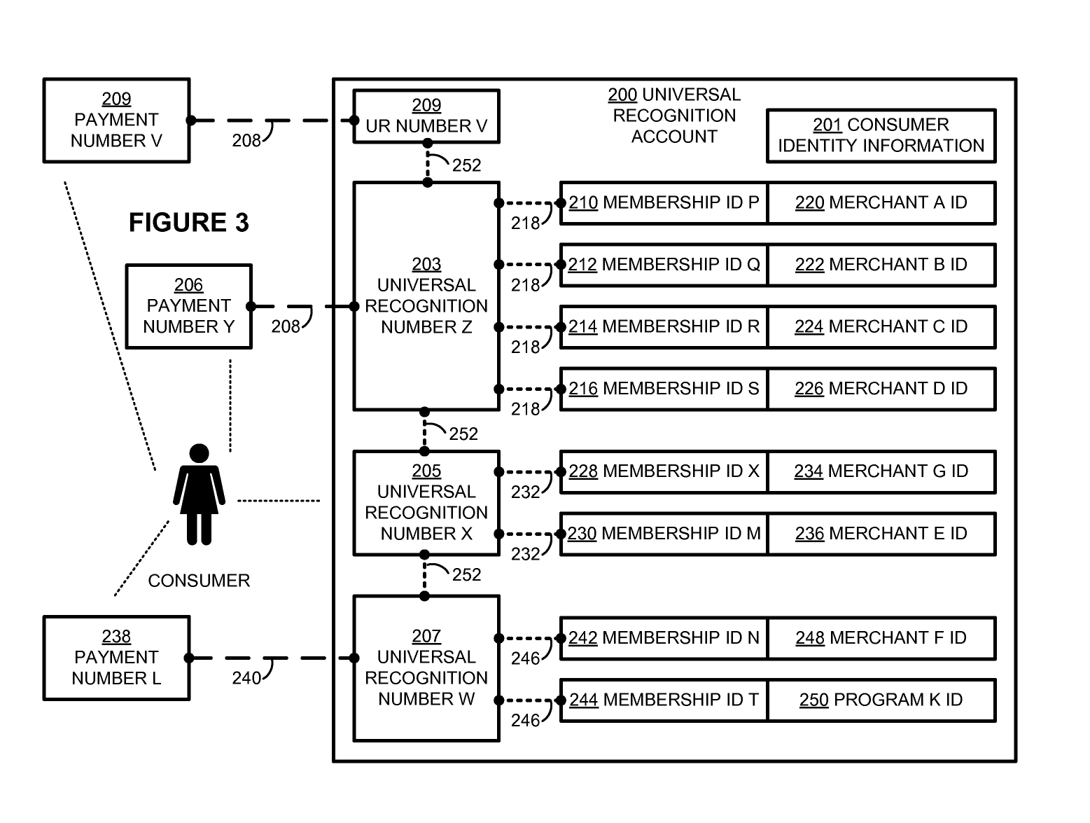

The combination of FIGS. 5-3 and 5-4 illustrates example methods for a consumer, for a merchant, for an acquirer data centre, for a payment processor data centre, for an issuer data centre and for a universal recognition and routing system, where the methods are for use with a payment token presenting a payment number associated with a universal recognition number that is linked to a membership identifier of the merchant's membership program, and where retrieval and routing of the universal recognition number is performed by the issuer data centre;

FIG. 6 illustrates example methods for a consumer, for a merchant, and for a URR system, where the methods are for use with a non-payment token presenting a universal recognition number that is not linked to a membership identifier of the merchant's membership program;

FIGS. 7-1 and 7-2 illustrate example methods for a consumer, for a merchant, for an acquirer data centre, for a payment processor data centre, for an issuer data centre and for a URR system, where the methods are for use with a payment token presenting a payment number associated with a universal recognition number that is not linked to a membership identifier of the merchant's membership program;

FIG. 8 illustrates an example method related to linking an existing membership identifier of a merchant's membership program to a universal recognition number of the consumer;

FIG. 9 illustrates an example method related to a consumer joining a merchant's membership program and linking a membership identifier of the program to a universal recognition number of the consumer;

FIG. 10 illustrates a schematic diagram of an example universal recognition system;

Appendix A provides an example UR receipt and an example UR response formatted, respectively, in accordance with the ISO 0600/0601 and ISO 0610 administrative data messages;

Appendix B provides an example payment receipt and an example payment response formatted, respectively, in accordance with the ISO 0100 and ISO 0110 administrative data messages; and

Appendix C provides an example UR receipt and an example UR response formatted, respectively, in accordance with the ISO 0100 and ISO 0110 administrative data messages.

### DETAILED DESCRIPTION

A “consumer” is herein defined as a person or entity seeking to be recognized by a membership program as part of a transaction with a merchant. The transaction may involve payment or may not involve payment. In one example, the transaction may simply be the grant or denial of admission or access. In another example, the transaction may also involve the accumulation or redemption of loyalty points. In yet another example, the transaction may further involve purchasing goods. Examples of merchants include gyms, museums, science centres, or other organizations that recognize their members. Other examples of merchants include clothing stores, drugstores, grocery stores, gas stations, bookstores, airlines, or other merchants that recognize members of their loyalty programs.

A “membership program” is herein defined as any program which recognizes its members. For example, a membership program may refer to an organization requiring membership for access, or may refer to a loyalty program affiliated with a merchant. A membership program may be exclusively affiliated with or managed by a particular merchant. Alternatively the membership program may be affiliated with multiple merchants and managed by a third party entity. In one example, numerous different merchants may have an agreement with the same frequent flyer loyalty program, such that purchases made at these different merchants may be used to accrue frequent flyer points with the loyalty program. A merchant may be affiliated with more than one membership program.

A “membership identifier” is herein defined as an identifier which can be used to uniquely identify a consumer's membership account within a membership program. One consumer may be a member of many membership programs, and may consequently have many membership identifiers. Each membership identifier may be presented in the form of a token, where “token” will herein be defined as any means for presenting a form of identification, such as a membership identifier or a payment number. Examples of tokens include membership cards, loyalty cards, credit cards, debit cards, e-wallets, key fobs, and the like. Other tokens may become available in the future. A membership identifier is a string of alphanumeric characters which may be stored and/or presented in the form of text, which is, for example, written or printed or embossed on the token. The membership identifier may alternatively or additionally be stored and/or presented in the form of one or more of a magnetic stripe, a barcode, an integrated circuit (e.g. a contact smart card), a radio frequency identifier (RFID) tag, a near field communications (NFC) tag (e.g. a contactless smart card), a hybrid smart card that works as both a contact smart card and a contactless smart card, and the like.

A “token capture device” is herein defined as the device used to capture information presented by the token, such as a membership identifier, a consumer's name, a consumer's address, a payment number, an expiration date, and the like. Examples of token capture devices include barcode scanners, payment card readers, and the like. For a virtual merchant, a token capture device is a user-interface in which the consumer enters information presented by the token.

A “point-of-sale device” is herein defined as the local hardware and/or software that is used at the location of a transaction. For example, in a grocery store, each checkout lane may include a token capture device and a point-of-sale device. The point-of-sale device may include a cash register and a computer. For a virtual merchant, the point-of-sale device is the online shopping cart functionality.

A “site” is herein defined as a particular branch of a merchant. For example, a grocery store chain may have multiple sites across Canada, each one located at a different physical address. A virtual merchant may have a single online site.

In the examples described herein, each site of a merchant includes at least one token capture device which is configured to capture at least a membership identifier or a payment number or both from a token presented at a point-of-sale device at the site. A token capture device may be incorporated into a point-of-sale device.

Membership identifiers are typically handled by a “membership system”, which may include hardware and/or software configured to operate the membership program. For example, a membership system may be configured to store, access, and modify information associated with membership accounts, such as member identity information, loyalty points, membership renewal deadlines, time of most recent use of membership, and the like. The membership system may be managed by the merchant itself or by the third party entity.

To minimize changes to existing software and processes used for financial transactions and membership recognition, the technology described herein may employ a data message format which conforms to existing communication standards used between merchants, membership systems, acquirer data centres, payment processor data centres, and/or issuer data centres. In one example, the UR platform may use a data message format which conforms to the ISO 8583:1987 standard. The ISO 8583 data message structure includes a header, application data, and a trailer. The application data consists of an ISO data message, which includes a Data message Type Indicator (MTI), a bitmap (indicating which data elements are present) and ISO Data Elements (the fields contained in the data message). An ISO data message that is sent from a merchant to another entity may be described as a receipt, whereas an ISO data message that is received by a merchant (or a membership system) from another entity may be described as a response. Transactions that do not involve payment typically entail ISO 0600/0601 administrative data messages, where the receipt is formatted as an ISO 0600 data message, and the response is formatted as an ISO 0610. Transactions that do involve payment typically entail ISO 0100 administrative data messages, where the receipt is formatted as an ISO 0100 data message, and the response is formatted as an ISO 0110 data message. In accordance with the ISO standard, a data message received at the URR system (from a participating merchant or from a payment transaction partner data centre) will herein be described as a “UR receipt” or “receipt data message”, whereas a data message sent by the UR system (to a partnering merchant or membership system or payment transaction partner data centre) will herein be described as a “UR response” or “response data message”. UR receipts may be similar in format to the ISO 0100 (or ISO 0600/0601) administrative data message, whereas UR responses may be similar in format to the ISO 0110 (or ISO 0610) administrative data message. To distinguish a UR receipt from a receipt that is used in payment processing, the latter will herein be described as a “payment receipt”. Similarly, to distinguish a UR response from a response that is used in payment processing, the latter will herein be described as a “payment response”. Appendix A provides an example UR receipt and an example UR response formatted, respectively, in accordance with the ISO 0600/0601 and ISO 0610 administrative data messages. Appendix B provides an example payment receipt and an example payment response formatted, respectively, in accordance with the ISO 0100 and ISO 0110 administrative data messages. Appendix C provides an example UR receipt and an example UR response formatted, respectively, in accordance with the ISO 0100 and ISO 0110 administrative data messages.

Single Non-Payment Token Presenting UR Number

FIG. 1 illustrates a schematic diagram of two example transactions at two different merchants, the transactions both involving the same non-payment token presenting the same UR number. A UR platform employs a universal recognition and routing (URR) system 2. The URR system 2 includes a UR database 4, one or more communication interfaces 6, and a switching subsystem 8 coupled to the UR database and to the one or more communication interfaces 6.

A consumer possesses a non-payment token 10 presenting a UR number X that is unique within the UR platform and uniquely recognizable by the URR system 2. Examples of non-payment tokens include membership cards, loyalty cards, and the like. The consumer possessing the token 10 is a member of a membership program of a merchant A 12 and is also a member of a membership program of a merchant B 14. Within the membership program of the merchant A 12, the consumer is identified by a membership identifier “P”. Within the membership program of the merchant B 14, the consumer is identified by a membership identifier “Q”. In one example, the consumer might seek to gain access to a site of merchant A 12, where the merchant A 12 is a gym, for example. The consumer might later seek to accrue loyalty points while making a purchase at the merchant B 14, where the merchant B 14 is a bookstore, for example. Since the token 10 is a non-payment token, the purchase at the merchant B 14 might be made using cash, as illustrated. Alternatively, the purchase could be made using a payment card presenting a payment number that is not associated with any UR number. For example, the purchase could be made using a gift card or using an unassociated credit card.

In the example of FIG. 1, the merchant A 12 and the merchant B 14 both participate in the UR platform's eco-system. The membership identifiers P and Q have previously been linked to the UR number X within the URR system 2.

When the consumer presents the token 10 to a token capture device 16 of the merchant A 12, the token capture device 16 captures the UR number X and provides the UR number to a point-of-sale device 18 of the merchant A 12.

Since the merchant A 12 participates in the UR platform's eco-system, the IIN range table at the point-of-sale device 18 is arranged so that the point-of-sale device 18 directs communications associated with UR numbers, such as the UR number X, to the URR system 2. This arrangement of the IIN range table at the point-of-sale device 18, and any logic and commands implemented at the point-of-sale device 18 for handling the UR number, is represented schematically as a circle 20. Accordingly, the point-of-sale device 18 generates and sends a UR receipt to the URR system 2, as illustrated by arrow 22, where the UR receipt contains, at a minimum, the UR number X and an identifier of the membership program for which the membership identifier is needed, for example, an identifier of the merchant A 12. The UR receipt may contain additional items to be described in more detail later.

Responsive to receiving the UR receipt via one of the communication interfaces 6, the switching subsystem 8 locates the UR number X in the database 4. Using the indication of the membership program (in this example, the identifier of the merchant A 12) that was contained in the UR receipt that was received (as illustrated by arrow 22), the switching subsystem 8 retrieves the corresponding membership identifier P that is linked to the UR number X. The switching subsystem 8 then generates a UR response which contains, at a minimum, the membership identifier P. The UR response may contain additional items to be described in more detail later. An agreement between the UR platform provider and the merchant A 12 may be used to determine where the UR response is sent. Options may include (a) to the merchant A 12, (b) to the point-of-sale device 18, (c) to a membership system 24, or (d) to some other system of the merchant A 12. The membership system 24 is illustrated as being contained within the merchant A 12, and thus may be considered to belong to the merchant A 12 and be managed by the merchant A 12. However, as described previously, the membership system 24 may alternatively be managed and/or belong to a third party entity. In the example of FIG. 1, the switching subsystem 8 uses the merchant identifier of the merchant A 12 to send the UR response, via one of the communication interfaces 6, to the merchant A 12, as illustrated by arrow 26. The membership identifier P is extracted from the UR response and used for recognition of the consumer in accordance with the traditional processes employed by the merchant A 12 and its membership system 24. For example, the membership identifier P may be used to grant access to merchant A 12, to accrue or redeem loyalty points with the membership program of the merchant A 12, and the like.

A similar sequence of events may take place when the token 10 is presented at the merchant B 14. When the consumer presents the token 10 to a token capture device 28 of the merchant B 14, the token capture device 28 captures the UR number X and provides the UR number X to a point-of-sale device 30 of the merchant B 14.

Since the merchant B 14 participates in the UR platform's eco-system, the IIN range table at the point-of-sale device 30 is arranged so that the point-of-sale device 30 directs communications associated with UR numbers, such as the UR number X, to the URR system 2. This arrangement of the IIN range table at the point-of-sale device 30, and any logic and commands implemented at the point-of-sale device 30 for handling the UR number, is represented schematically as the circle 20. Accordingly, the point-of-sale device 30 generates and sends a UR receipt to the URR system 2, as illustrated by arrow 32, where the UR receipt contains, at a minimum, the UR number X and an indication of the membership program for which a membership identifier is needed, for example, an identifier of merchant B 14. The UR receipt may contain additional items to be described in more detail later.

Responsive to receiving the UR receipt via one of the communication interfaces 6, the switching subsystem 8 locates the UR number X in the database 4. Using the indication of the membership program (in this example, the identifier of the merchant B 14) that was contained in the UR receipt that was received (as illustrated by arrow 32), the switching subsystem 8 retrieves the corresponding membership identifier Q that is linked to the UR number X. The switching subsystem 8 then generates a UR response which contains, at a minimum, the membership identifier Q. The UR response may contain additional items to be described in more detail later. As described with respect to the merchant A 12, an agreement between the UR platform provider and the merchant B 14 may be used to determine where the UR response is sent. In the example of FIG. 1, the switching subsystem 8 uses the merchant identifier of the merchant B 14 to send the UR response, via one of the communication interfaces 6, to the merchant B 14, as illustrated by arrow 34. However, the UR response could alternatively be sent directly to the point-of-sale device 30, to a membership system 36 of the merchant B 14, or to some other system of the merchant B 14. The membership identifier Q is extracted from the UR response and used for recognition of the consumer in accordance with the traditional processes employed by the merchant B 14 and its membership system 36. For example, the membership identifier Q may be used to grant access to the merchant B 14, to accrue or redeem loyalty points with the membership program of the merchant B 14, and the like.

Importantly, in the example of FIG. 1, the consumer is using the same token 10 to be recognized by a membership program of the merchant A 12 and by a membership program of the merchant B 14. That is, rather than using separate tokens, each presenting a different membership identifier, the consumer is using a single token 10 which presents a single UR number X. The URR system 2 effectively translates the UR number X into the appropriate membership identifier (P or Q), depending on the particular merchant at which the token 10 is presented.

Although not explicitly illustrated in FIG. 1, communication of the UR receipt from the point-of-sale device 18 to the URR system 2 occurs over communication networks using a network service agreed upon between the merchant A 12 and the UR platform provider, and communication of the UR receipt from the point-of-sale device 30 to the URR system 2 occurs over communication networks using a network service agreed upon between the merchant B 14 and the UR platform provider. The point-of-sale devices 18, 30 address the UR receipts to an Internet Protocol (IP) address of the URR system 2. Furthermore, communication of the UR response from the URR system 2 (to the merchant, to the membership program, to the point-of-sale device, or elsewhere as agreed upon) occurs over communication networks using a network service agreed upon between the URR system 2 and the recipient of the UR response. Examples of network services include virtual private networking (VPN), multiprotocol label switching (MPLS), and frame relay. Authentication and encryption techniques may be employed for the communication of the UR receipt and the communication of the UR response. The communication networks via which the UR receipts and the UR responses are communicated are not part of any payment communication network.

Single Payment Token Presenting Payment Number Associated with UR Number (Payment Transaction Partner is Payment Processor)

FIG. 2-1 illustrates a schematic diagram of two example transactions at two different merchants, the transactions both involving the same payment token presenting the same payment number associated with the same UR number.

A consumer possesses a payment token (also known as a payment device) 38 presenting a payment number Y that is associated with a UR number Z, where the UR number Z is unique within the UR platform and uniquely recognizable by the URR system 2. Examples of payment tokens include credit cards, debit cards, charge cards, e-wallets, and the like. The payment number Y carries a brand of a payment processor 40 and was issued to the consumer by an issuer 42. For example, the payment number 5181 2712 3456 7890 is a Mastercard® credit card number and is issued by President's Choice Bank. The consumer possessing the token is a member of a membership program of a merchant C 44 and is also a member of a membership program of a merchant D 46. Within the membership program of the merchant C 44, the consumer is identified by a membership identifier “R”. Within the membership program of the merchant D 46, the consumer is identified by a membership identifier “S”. In one example, the consumer might seek to accrue loyalty points in the membership program of the merchant C 44 while making a purchase at the merchant C 44, where the merchant C 44 is a grocery store, for example. The consumer might later seek to redeem loyalty points in the membership program of the merchant D 46, where the merchant D 46 is a hardware store, for example. According to the technology described herein, the consumer may use the same payment token 38 for both of these example transactions.

In the example of FIG. 2-1, the merchant C 44 and the merchant D 46 both participate in the UR platform's eco-system. The membership identifiers R and S have previously been linked to the UR number Z within the URR system 2.

In the example of FIG. 2-1, the payment processor is a payment transaction partner with the UR platform provider. The payment number Y has previously been associated with the UR number Z within the payment processor data centre 40. For example, the UR number Z may have been part of a pool of UR numbers allocated to the payment processor by the UR platform provider, and the payment processor data centre 40 may have associated the UR number Z with the payment number Y.

When the consumer presents the payment token 38 to a token capture device 48 of the merchant C 44, the token capture device 48 captures the payment number Y and provides the payment number Y to a point-of-sale device 50 of the merchant C 44. In accordance with traditional processing of a financial transaction, the point-of-sale device 50 then sends a payment receipt to an acquirer data centre 52, as illustrated by arrow 54, where the payment receipt necessarily contains the payment number Y and an identifier of the merchant C 44. The payment receipt may contain additional items to be described in more detail later. The acquirer data centre 52 sends the payment receipt to the payment processor data centre 40, as illustrated by arrow 56, and the payment processor data centre 40 in turn sends the payment receipt to an issuer data centre 42, as illustrated by arrow 58. After making a determination whether to approve or to deny the transaction, the issuer data centre 42 sends a payment response back to the payment processor data centre 40, as illustrated by arrow 60, where the payment response contains an indication of whether the transaction was approved or denied. The payment processor data centre 40 in turn sends the payment response to the acquirer data centre 52, as illustrated by arrow 62, and the acquirer data centre 52 then sends the payment response to the merchant C 44, as illustrated by arrow 64. Communication of the payment receipt from the point-of-sale device 50 to the acquirer data centre 52 to the payment processor data centre 40 to the issuer data centre 42 and communication of the payment response from the issuer data centre 42 to the payment processor data centre 40 to the acquirer data centre 52 to the merchant C 44 occur via payment communication networks, as known in the art.

Since the payment processor is a payment transaction partner with the UR platform provider, the payment processor data centre 40 maintains a table 66 of payment numbers that are associated to UR numbers, where each payment number in the table 66 is associated with a single UR number in the table 66. Logic and commands are implemented at the payment processor data centre 40, so that the payment processor data centre 40 is able to retrieve from the table 66 a UR number associated with a payment number, and send the UR number to the URR system 2. Accordingly, when the payment processor data centre 40 receives the payment receipt from the acquirer data centre 52, as illustrated by arrow 56, the payment processor data centre 40 uses the table 66 of payment numbers and associated UR numbers to retrieve the UR number Z that is associated with the payment number Y. The payment processor data centre 40 then generates and sends a UR receipt to the URR system 2, as illustrated by arrow 68, where the UR receipt contains, at a minimum, the UR number Z and an indication of the membership program for which a membership identifier is needed, for example, the identifier of the merchant C 44. The UR receipt may contain additional items to be described in more detail later. The payment processor data centre 40 sends the UR receipt to the URR system 2, as illustrated by arrow 68, via a communication network that is not part of any payment communication network.

Responsive to receiving the UR receipt via one of the communication interfaces 6, the switching subsystem 8 locates the UR number Z in the database 4. Using the indication of the membership program (in this example, the identifier of the merchant C 44) that was contained in the UR receipt that was received (as illustrated by arrow 68), the switching subsystem 8 retrieves the corresponding membership identifier R that is linked to the UR number Z. The switching subsystem 8 then generates a UR response which contains, at a minimum, the membership identifier R. The UR response may contain additional items to be described in more detail later. As described with respect to FIG. 1, an agreement between the UR platform provider and the merchant C 44 may be used to determine where the UR response is sent. Options may include (a) to the merchant C 44, (b) to the point-of-sale device 50, (c) to a membership system 70, or (d) to some other system of the merchant C 44. The membership system 70 may belong to and/or be managed by the merchant C 44 or may belong to and/or be managed by a third party entity. In the example of FIG. 2-1, the switching subsystem 8 uses the merchant identifier of the merchant C 44 to send the UR response, via one of the communication interfaces 6, to the merchant C 44, as illustrated by arrow 72. The membership identifier R is extracted from the UR response and used for recognition of the consumer in accordance with the traditional processes employed by the merchant C 44 and its membership system 70. For example, the membership identifier R may be used to grant access to merchant C 44, to accrue or redeem loyalty points with the membership program of the merchant C 44, and the like. The membership identifier R may be handled differently depending on whether the payment response sent by the acquirer data centre 52 (as illustrated by arrow 64) indicates that the transaction was approved or denied. For example, if a transaction has been denied, there may be no accrual of loyalty points for the denied transaction in the consumer's membership account having the membership identifier R.

The URR system 2 sends the UR response to the merchant C 44, as illustrated by arrow 72, via a communication network that is not part of any payment communication network. In an alternate implementation, the URR system 2 may send the UR response back to the payment processor data centre 40, as illustrated by arrow 73, via a communication network that is not part of any payment communication network. For example, the UR response may be sent to the payment processor data centre 40 via the same communication network used by the payment processor data centre 40 to send the UR receipt to the URR system 2. In that alternate implementation, the payment processor data centre 40 may postpone communicating the payment response received from the issuer data centre 42 until the UR response is received from the URR system 2. For example, responsive to receiving the UR response from the URR system 2, the payment processor data centre 40 may extract the membership identifier R from the UR response and include the membership identifier R in the payment response, which is then communicated via the payment communication networks back to the acquirer data centre 52 for further communication via the payment communication networks to the merchant C 44. In another example, responsive to receiving the UR response from the URR system 2, the payment processor data centre 40 may communicate the payment response together with the UR response via the payment communication networks back to the acquirer data centre 52 for further communication via the payment communication networks to the merchant C 44.

A similar sequence of events may take place when the payment token 38 is presented at the merchant D 46. When the consumer presents the payment token 38 to a token capture device 74 of the merchant D 46, the token capture device 74 captures the payment number Y and provides the payment number Y to a point-of-sale device 76 of the merchant D 46. In accordance with traditional processing of a financial transaction, the point-of-sale device 76 then sends a payment receipt to an acquirer data centre 78, as illustrated by arrow 80, where the payment receipt necessarily contains the payment number Y and an identifier of the merchant D 46. The payment receipt may contain additional items to be described in more detail later. In the example of FIG. 2-1, the acquirer data centre 78 is illustrated as separate from the acquirer data centre 52. However it is possible that the merchant C 44 and the merchant D 46 may use the same acquirer data centre. The acquirer data centre 78 sends the payment receipt to the payment processor data centre 40, as illustrated by arrow 82, and the payment processor data centre 40 in turn sends the payment receipt to the issuer data centre 42, as illustrated by arrow 84. After making a determination whether to approve or to deny the transaction, the issuer data centre 42 sends a payment response back to the payment processor data centre 40, as illustrated by arrow 86, where the payment response contains an indication of whether the transaction was approved or denied. The payment processor data centre 40 in turn sends the payment response to the acquirer data centre 78, as illustrated by arrow 88, and the acquirer data centre 78 then sends the payment response to the merchant D 46, as illustrated by arrow 90. Communication of the payment receipt from the point-of-sale device 76 to the acquirer data centre 78 to the payment processor data centre 40 to the issuer data centre 42 and communication of the payment response from the issuer data centre 42 to the payment processor data centre 40 to the acquirer data centre 78 to the merchant D 46 occur via payment communication networks, as known in the art.

When the payment processor data centre 40 receives the payment receipt from the acquirer data centre 52, as illustrated by arrow 82, the payment processor data centre 40 uses the table 66 of payment numbers and associated UR numbers to retrieve the UR number Z that is associated with the payment number Y. The payment processor data centre 40 then generates and sends a UR receipt to the URR system 2, as illustrated by arrow 92, where the UR receipt contains, at a minimum, the UR number Z and an indication of the membership program for which a membership identifier is needed, for example, the identifier of merchant D 46. The UR receipt may contain additional items to be described in more detail later. The payment processor data centre 40 sends the UR receipt to the URR system 2, as illustrated by arrow 92, via a communication network that is not part of any payment communication network.

Responsive to receiving the UR receipt via one of the communication interfaces 6, the switching subsystem 8 locates the UR number Z in the database 4. Using the indication of the membership program (in this example, the identifier of the merchant D 46) that was contained in the UR receipt that was received (as illustrated by arrow 92), the switching subsystem 8 retrieves the corresponding membership identifier S that is linked to the UR number Z. The switching subsystem 8 then generates a UR response which contains, at a minimum, the membership identifier S. The UR response may contain additional items to be described in more detail later. As described with respect to merchant C 44, an agreement between the UR platform provider and the merchant D 46 may be used to determine where the UR response is sent. In the example of FIG. 2-1, the switching subsystem 8 uses the merchant identifier of the merchant D 46 to send the UR response, via one of the communication interfaces 6, to the merchant D 46, as illustrated by arrow 94. However, the UR response could alternatively be sent directly to the point-of-sale device 76, to a membership system 96 of the merchant D 46, or to some other system of the merchant D 14. The membership identifier S is extracted from the UR response and used for recognition of the consumer in accordance with the traditional processes employed by the merchant D 46 and its membership system 96. For example, the membership identifier S may be used to grant access to the merchant D 46, to accrue or redeem loyalty points with the membership program of the merchant D 46, and the like. The membership identifier S may be handled differently depending on whether the payment response sent by the acquirer data centre 78 (as illustrated by arrow 90) indicates that the transaction was approved or denied.

The URR system 2 sends the UR response to the merchant D 46, as illustrated by arrow 94, via a communication network that is not part of any payment communication network. In an alternate implementation, the URR system 2 may send the UR response back to the payment processor data centre 40, as illustrated by arrow 95, via a communication network that is not part of any payment communication network. For example, the UR response may be sent to the payment processor data centre 40 via the same communication network used by the payment processor data centre 40 to send the UR receipt to the URR system 2. In that alternate implementation, the payment processor data centre 40 may postpone communicating the payment response received from the issuer data centre 42 until the UR response is received from the URR system 2. For example, responsive to receiving the UR response from the URR system 2, the payment processor data centre 40 may extract the membership identifier S from the UR response and include the membership identifier S in the payment response, which is then communicated via the payment communication networks back to the acquirer data centre 78 for further communication via the payment communication networks to the merchant D 46. In another example, responsive to receiving the UR response from the URR system 2, the payment processor data centre 40 may communicate the payment response together with the UR response via the payment communication networks back to the acquirer data centre 78 for further communication via the payment communication networks to the merchant D 46.

Importantly, in the example of FIG. 2-1, the consumer is using the same token 38 to be recognized by a membership program of the merchant C 44 and by a membership program of merchant D 46. Furthermore, because the token 38 is a payment token, the consumer is also able to use the token 38 to make purchases at both merchants. That is, rather than using two separate tokens, each presenting a different membership identifier, and rather than using a separate payment device presenting a payment number, the consumer is using a single token 38 which presents a single payment number Y. Since the payment processor is a payment transaction partner with the UR platform provider, the payment processor data centre 40 is able to retrieve the UR number Z that is associated with the payment number Y, and to provide the UR number Z to the URR system 2. The URR system 2 effectively translates the UR number Z into the appropriate membership identifier (R or S), depending on the particular merchant at which the token 38 is presented.

Single Payment Token Presenting Payment Number Associated with UR Number (Payment Transaction Partner is Issuer)

FIG. 2-2 illustrates a schematic diagram of two example transactions at two different merchants, the transactions both involving the same payment token presenting the same payment number associated with the same UR number.

The same consumer who possesses the payment token 38 presenting the payment number Y also possesses a payment token 98 presenting a payment number L that is associated with a UR number W, where the UR number W is unique within the UR platform and uniquely recognizable by the URR system 2. The payment number L carries a brand of a payment processor and was issued to the consumer by an issuer. For example, the payment number 4519 0212 3456 7890 is an INTERAC® debit card number and is issued by The Royal Bank of Canada.

In the example of FIG. 2-2, an issuer is a payment transaction partner with the UR platform provider. The payment number L has previously been associated with the UR number W within an issuer data centre 102. For example, the UR number W may have been part of a pool of UR numbers allocated to the issuer by the UR platform provider, and the issuer data centre 102 may have associated the UR number W with the payment number L.

According to the technology described herein, the consumer may use the payment token 98 for transactions at the merchant C 44 and at the merchant D 46, where the consumer wishes to be recognized as a member of the membership program of the merchant C 44 and as a member of the membership program of the merchant D 46.

When the consumer presents the payment token 98 to the token capture device 48 of the merchant C 44, the token capture device 48 captures the payment number L and provides the payment number L to the point-of-sale device 50 of the merchant C 44. In accordance with traditional processing of a financial transaction, the point-of-sale device 50 then sends a payment receipt to the acquirer data centre 52, as illustrated by arrow 104, where the payment receipt necessarily contains the payment number L and an identifier of the merchant C 44. The payment receipt may contain additional items to be described in more detail later. The acquirer data centre 52 sends the payment receipt to a payment processor data centre 100, as illustrated by arrow 106, and the payment processor data centre 100 in turn sends the payment receipt to the issuer data centre 102, as illustrated by arrow 108. After making a determination whether to approve or to deny the transaction, the issuer data centre 102 sends a payment response back to the payment processor data centre 100, as illustrated by arrow 110, where the payment response contains an indication of whether the transaction was approved or denied. The payment processor data centre 100 in turn sends the payment response to the acquirer data centre 52, as illustrated by arrow 112, and the acquirer data centre 52 then sends the payment response to the merchant C 44, as illustrated by arrow 114. Communication of the payment receipt from the point-of-sale device 50 to the acquirer data centre 52 to the payment processor data centre 100 to the issuer data centre 102 and communication of the payment response from the issuer data centre 102 to the payment processor data centre 100 to the acquirer data centre 52 to the merchant C 44 occur via payment communication networks, as known in the art.

Since the issuer is a payment transaction partner with the UR platform provider, the issuer data centre 102 maintains a table 116 of payment numbers that are associated to UR numbers, where each payment number in the table 116 is associated with a single UR number in the table 116. Logic and commands are implemented at the issuer data centre 102, so that the issuer data centre 102 is able to retrieve from the table 116 a UR number associated with a payment number, and send the UR number to the URR system 2. Accordingly, when the issuer data centre 102 receives the payment receipt from the payment processor data centre 100, as illustrated by arrow 108, the issuer data centre 102 uses the table 116 of payment numbers and associated UR numbers to retrieve the UR number W that is associated with the payment number L. The issuer data centre 102 then generates and sends a UR receipt to the URR system 2, as illustrated by arrow 118, where the UR receipt contains, at a minimum, the UR number W and an indication of the membership program for which a membership identifier is needed, for example, the identifier of the merchant C 44. The UR receipt may contain additional items to be described in more detail later. The issuer data centre 102 sends the UR receipt to the URR system 2, as illustrated by arrow 118, via a communication network that is not part of any payment communication network.

Responsive to receiving the UR receipt via one of the communication interfaces 6, the switching subsystem 8 locates the UR number W in the database 4. Using the indication of the membership program (in this example, the identifier of the merchant C 44) that was contained in the UR receipt that was received (as illustrated by arrow 118), the switching subsystem 8 retrieves the corresponding membership identifier R that is linked to the UR number W. The switching subsystem 8 then generates a UR response which contains, at a minimum, the membership identifier R. The UR response may contain additional items to be described in more detail later. As described with respect to FIG. 2-1, an agreement between the UR platform provider and the merchant C 44 may be used to determine where the UR response is sent. In the example of FIG. 2-2, the switching subsystem 8 uses the merchant identifier of the merchant C 44 to send the UR response, via one of the communication interfaces 6, to the merchant C 44, as illustrated by arrow 120. The membership identifier R is extracted from the UR response and used for recognition of the consumer in accordance with the traditional processes employed by the merchant C 44 and its membership system 70.

The URR system 2 sends the UR response to the merchant C 44, as illustrated by arrow 120, via a communication network that is not part of any payment communication network. In an alternate implementation, the URR system 2 may send the UR response back to the issuer data centre 102, as illustrated by arrow 121, via a communication network that is not part of any payment communication network. For example, the UR response may be sent to the issuer data centre 102 via the same communication network used by the issuer data centre 102 to send the UR receipt to the URR system 2. In that alternate implementation, the issuer data centre 102 may postpone communicating the payment response that it generates until the UR response is received from the URR system 2. For example, responsive to receiving the UR response from the URR system 2, the issuer data centre 102 may extract the membership identifier R from the UR response and include the membership identifier R in the payment response, which is then communicated via the payment communication networks back to the payment processor data centre 100 for further communication via the payment communication networks to the acquirer data centre 52 and then to the merchant C 44. In another example, responsive to receiving the UR response from the URR system 2, the issuer data centre 102 may communicate the payment response together with the UR response via the payment communication networks back to the payment processor data centre 100 for further communication via the payment communication networks to the acquirer data centre 52 and then to the merchant C 44.

A similar sequence of events may take place when the payment token 98 is presented at the merchant D 46. When the consumer presents the payment token 98 to the token capture device 74 of the merchant D 46, the token capture device 74 captures the payment number L and provides the payment number L to the point-of-sale device 76 of the merchant D 46. In accordance with traditional processing of a financial transaction, the point-of-sale device 76 then sends a payment receipt to the acquirer data centre 78, as illustrated by arrow 122, where the payment receipt necessarily contains the payment number Y and an identifier of the merchant D 46. The payment receipt may contain additional items to be described in more detail later. The acquirer data centre 78 sends the payment receipt to the payment processor data centre 100, as illustrated by arrow 124, and the payment processor data centre 100 in turn sends the payment receipt to the issuer data centre 102, as illustrated by arrow 126. After making a determination whether to approve or to deny the transaction, the issuer data centre 102 sends a payment response back to the payment processor data centre 100, as illustrated by arrow 128, where the payment response contains an indication of whether the transaction was approved or denied. The payment processor data centre 100 in turn sends the payment response to the acquirer data centre 78, as illustrated by arrow 130, and the acquirer data centre 78 then sends the payment response to the merchant D 46, as illustrated by arrow 132. Communication of the payment receipt from the point-of-sale device 76 to the acquirer data centre 78 to the payment processor data centre 100 to the issuer data centre 102 and communication of the payment response from the issuer data centre 102 to the payment processor data centre 100 to the acquirer data centre 78 to the merchant D 46 occur via payment communication networks, as known in the art.

When the issuer data centre 102 receives the payment receipt from the payment processor data centre, as illustrated by arrow 126, the issuer data centre 102 uses the table 116 of payment numbers and associated UR numbers to retrieve the UR number W that is associated with the payment number L. The issuer data centre 102 then generates and sends a UR receipt to the URR system 2, as illustrated by arrow 134, where the UR receipt contains, at a minimum, the UR number W and an indication of the membership program for which a membership identifier is needed, for example, the identifier of the merchant D 46. The UR receipt may contain additional items to be described in more detail later. The issuer data centre 102 sends the UR receipt to the URR system 2, as illustrated by arrow 134, via a communication network that is not part of any payment communication network.

Responsive to receiving the UR receipt via one of the communication interfaces 6, the switching subsystem 8 locates the UR number W in the database 4. Using the indication of the membership program (in this example, the identifier of the merchant D 46) that was contained in the UR receipt that was received (as illustrated by arrow 134), the switching subsystem 8 retrieves the corresponding membership identifier S that is linked to the UR number W. The switching subsystem 8 then generates a UR response which contains, at a minimum, the membership identifier S. The UR response may contain additional items to be described in more detail later. As described with respect to FIG. 2-1, an agreement between the UR platform provider and the merchant D 46 may be used to determine where the UR response is sent. In the example of FIG. 2-2, the switching subsystem 8 uses the merchant identifier of the merchant D 46 to send the UR response, via one of the communication interfaces 6, to the merchant D 46, as illustrated by arrow 136. The membership identifier S is extracted from the UR response and used for recognition of the consumer in accordance with the traditional processes employed by the merchant D 46 and its membership system 96.

The URR system 2 sends the UR response to the merchant D 46, as illustrated by arrow 136, via a communication network that is not part of any payment communication network. In an alternate implementation, the URR system 2 may send the UR response back to the issuer data centre 102, as illustrated by arrow 137, via a communication network that is not part of any payment communication network. For example, the UR response may be sent to the issuer data centre 102 via the same communication network used by the issuer data centre 102 to send the UR receipt to the URR system 2. In that alternate implementation, the issuer data centre 102 may postpone communicating the payment response that it generates until the UR response is received from the URR system 2. For example, responsive to receiving the UR response from the URR system 2, the issuer data centre 102 may extract the membership identifier S from the UR response and include the membership identifier S in the payment response, which is then communicated via the payment communication networks back to the payment processor data centre 100 for further communication via the payment communication networks to the acquirer data centre 78 and then to the merchant D 46. In another example, responsive to receiving the UR response from the URR system 2, the issuer data centre 102 may communicate the payment response together with the UR response via the payment communication networks back to the payment processor data centre 100 for further communication via the payment communication networks to the acquirer data centre 78 and then to the merchant D 46.

Importantly, in the example of FIG. 2-2, the consumer is using the same token 98 to be recognized by a membership program of the merchant C 44 and by a membership program of merchant D 46. Furthermore, because the token 98 is a payment token, the consumer is also able to use the token 98 to make purchases at both merchants. That is, rather than using two separate tokens, each presenting a different membership identifier, and rather than using a separate payment device presenting a payment number, the consumer is using a single token 98 which presents a single payment number L. Since the issuer is a payment transaction partner with the UR platform provider, the issuer data centre 102 is able to retrieve the UR number W that is associated with the payment number L, and to provide the UR number W to the URR system 2. The URR system 2 effectively translates the UR number W into the appropriate membership identifier (R or S), depending on the particular merchant at which the token 98 is presented.

Furthermore, the UR platform enables the consumer to be recognized by the membership program of the merchant C 44 both when using the token 38 presenting the payment number Y (as described with respect to FIG. 2-1) and when using the token 98 presenting the payment number L (as described with respect to FIG. 2-2). Similarly, the UR platform enables the consumer to be recognized by the membership program of the merchant D 46 both when using the token 38 presenting the payment number Y (as described with respect to FIG. 2-1) and when using the token 98 presenting the payment number L (as described with respect to FIG. 2-2). This result is achieved even though financial transactions involving the payment number Y are processed by the payment processor data centre 40 and the issuer data centre 42, and financial transactions involving the payment number L are processed by the payment processor data centre 100 and the issuer data centre 102. This result is achieved even though generation of the UR receipt for transactions involving the payment number Y occurs at the payment processor data centre 40 and generation of the UR receipt for transactions involving the payment number L occurs at the issuer data centre 102.

URR System Works with Data Centres of Multiple Payment Transaction Partners

Accordingly, the consumer has the flexibility to use either the token 38 presenting the payment number Y or the token 98 presenting the payment number L for transactions at participating merchants, and to still be recognized as a member in the respective membership programs of the participating merchants. This flexibility is illustrated in FIG. 2-3, which illustrates a schematic diagram of two example transactions at two different merchants, the transactions involving different payment tokens presenting different payment numbers associated with different UR numbers, but where the same consumer possesses the different payment tokens. Details of the two example transactions are described above with respect to FIG. 2-1 and FIG. 2-2.

Since the merchant C 44 and the merchant D 46 participate in the UR platform's eco-system, the IIN range table at the point-of-sale device 50 and the IIN range table at the point-of-sale device 76 are arranged so that the point-of-sale devices direct communications associated with UR numbers, such as the UR number X, to the URR system 2. This arrangement of the IIN table at the point-of-sale devices, and any logic and commands implemented at the point-of-sale devices 50, 76 for handling the UR number, is represented schematically as the circle 20. The operation of the point-of-sale devices when receiving a UR number captured from a non-payment token is as described above with respect to FIG. 1. However, this arrangement of the IIN table and operation of the point-of-sale devices is not necessary for the operation of the point-of-sale device 50 as described with respect to FIGS. 2-1, 2-2 and 2-3 and is not necessary for the operation of the point-of-sale device 76 as described with respect to FIGS. 2-1, 2-2 and 2-3.

Different Payment Tokens Presenting Different Payment Numbers Associated with Different UR Numbers (Payment Transaction Partner is Acquirer)

FIG. 2-4 illustrates a schematic diagram of two example transactions at two different merchants, the transactions involving different payment tokens presenting different payment numbers associated with different UR numbers, but where the same consumer possesses the different payment tokens.

In the example of FIG. 2-4, an acquirer is a payment transaction partner with the UR platform provider. The payment number Y has previously been associated with the UR number Z within an acquirer data centre 138 and the payment number L has previously been associated with the UR number W within the acquirer data centre 138.

The consumer possesses the payment token 38 presenting the payment number Y that is associated with the UR number Z, and the payment token 98 presenting the payment number L that is associated with the UR number W. The consumer is a member of a membership program of a merchant E 140 and is also a member of a membership program of a merchant F 142. Within the membership program of the merchant E 140, the consumer is identified by a membership identifier “M”. Within the membership program of the merchant F 142, the consumer is identified by a membership identifier “N”. In one example, the consumer might seek to redeem loyalty points in the membership program of the merchant E 140 while making a purchase at the merchant E 140, where the merchant E 140 is a clothing store, for example. The consumer might later seek to accrue loyalty points in the membership program of the merchant F 142, where the merchant F 142 is a liquor store, for example.

In the example of FIG. 2-4, the merchant E 140 and the merchant F 142 both participate in the UR platform's eco-system. The membership identifiers M and N have previously been linked to the UR number Z and to the UR number W within the URR system 2. Moreover, both the merchant E 140 and the merchant F 142 send payment receipts to the acquirer data centre 138 for processing of financial transactions.

When the consumer presents the payment token 38 to a token capture device 49 of the merchant E 140, the token capture device 49 captures the payment number Y and provides the payment number Y to a point-of-sale device 51 of the merchant E 140. In accordance with traditional processing of a financial transaction, the point-of-sale device 51 then sends a payment receipt to the acquirer data centre 138, as illustrated by arrow 144, where the payment receipt necessarily contains the payment number Y and an identifier of the merchant E 140. The payment receipt may contain additional items to be described in more detail later. The traditional processing of the financial transaction continues as described above with respect to FIGS. 2-1 and 2-2, with communication of the payment receipt and the payment response occurring via payment communication networks, as known in the art.

Since the acquirer is a payment transaction partner with the UR platform provider, the acquirer data centre 138 maintains a table 146 of payment numbers that are associated to UR numbers, where each payment number in the table 146 is associated with a single UR number in the table 146. Logic and commands are implemented at the acquirer data centre 138, so that the acquirer data centre 138 is able to retrieve from the table 146 a UR number associated with a payment number, and send the UR number to the URR system 2. Accordingly, when the acquirer data centre 138 receives the payment receipt from the point-of-sale device 51, as illustrated by arrow 144, the acquirer data centre 138 uses the table 146 of payment numbers and associated UR numbers to retrieve the UR number Z that is associated with the payment number Y. The acquirer data centre 138 then generates and sends a UR receipt to the URR system 2, as illustrated by arrow 148, where the UR receipt contains, at a minimum, the UR number Z and an indication of the membership program for which a membership identifier is needed, for example, the identifier of the merchant E 140. The UR receipt may contain additional items to be described in more detail later. The acquirer data centre 138 sends the UR receipt to the URR system 2, as illustrated by arrow 148, via a communication network that is not part of any payment communication network.

Responsive to receiving the UR receipt via one of the communication interfaces 6, the switching subsystem 8 locates the UR number Z in the database 4. Using the indication of the membership program (in this example, the identifier of the merchant E 140) that was contained in the UR receipt that was received (as illustrated by arrow 148), the switching subsystem 8 retrieves the corresponding membership identifier M that is linked to the UR number Z. The switching subsystem 8 then generates a UR response which contains, at a minimum, the membership identifier M. The UR response may contain additional items to be described in more detail later. An agreement between the UR platform provider and the merchant E 140 may be used to determine where the UR response is sent. In the example of FIG. 2-4, the switching subsystem 8 uses the merchant identifier of the merchant E 140 to send the UR response, via one of the communication interfaces 6, to the merchant E 140, as illustrated by arrow 150. The membership identifier M is extracted from the UR response and used for recognition of the consumer in accordance with the traditional processes employed by the merchant E 140 and its membership system 152.

The URR system 2 sends the UR response to the merchant E 140, as illustrated by arrow 150, via a communication network that is not part of any payment communication network. In an alternate implementation, the URR system 2 may send the UR response back to the acquirer data centre 138, as illustrated by arrow 151, via a communication network that is not part of any payment communication network. For example, the UR response may be sent to the acquirer data centre 138 via the same communication network used by the acquirer data centre 138 to send the UR receipt to the URR system 2. In that alternate implementation, the acquirer data centre 138 may postpone communicating the payment response received from the payment processor data centre 40 until the UR response is received from the URR system 2. For example, responsive to receiving the UR response from the URR system 2, the acquirer data centre 138 may extract the membership identifier M from the UR response and include the membership identifier M in the payment response, which is then communicated via the payment communication networks back to the merchant E 140. In another example, responsive to receiving the UR response from the URR system 2, the acquirer data centre 138 may communicate the payment response together with the UR response via the payment communication networks back to the merchant E 140.

A similar sequence of events may take place when the payment token 98 is presented at the merchant F 142. When the consumer presents the payment token 98 to a token capture device 154 of the merchant F 142, the token capture device 154 captures the payment number L and provides the payment number L to a point-of-sale device 156 of the merchant F 142. In accordance with traditional processing of a financial transaction, the point-of-sale device 156 then sends a payment receipt to the acquirer data centre 138, as illustrated by arrow 158, where the payment receipt necessarily contains the payment number L and an identifier of the merchant F 142. The payment receipt may contain additional items to be described in more detail later. The traditional processing of the financial transaction continues as described above with respect to FIGS. 2-1 and 2-2, with communication of the payment receipt and the payment response occurring via payment communication networks, as known in the art.

When the acquirer data centre 138 receives the payment receipt from the point-of-sale device 156, as illustrated by arrow 158, the acquirer data centre 138 uses the table 146 of payment numbers and associated UR numbers to retrieve the UR number W that is associated with the payment number L. The acquirer data centre 138 then generates and sends a UR receipt to the URR system 2, as illustrated by arrow 160, where the UR receipt contains, at a minimum, the UR number W and an indication of the membership program for which a membership identifier is needed, for example, the identifier of the merchant F 142. The UR receipt may contain additional items to be described in more detail later. The acquirer data centre 138 sends the UR receipt to the URR system 2, as illustrated by arrow 160, via a communication network that is not part of any payment communication network.

Responsive to receiving the UR receipt via one of the communication interfaces 6, the switching subsystem 8 locates the UR number W in the database 4. Using the indication of the membership program (in this example, the identifier of the merchant F 142) that was contained in the UR receipt that was received (as illustrated by arrow 160), the switching subsystem 8 retrieves the corresponding membership identifier N that is linked to the UR number W. The switching subsystem 8 then generates a UR response which contains, at a minimum, the membership identifier N. The UR response may contain additional items to be described in more detail later. An agreement between the UR platform provider and the merchant F 142 may be used to determine where the UR response is sent. In the example of FIG. 2-4, the switching subsystem 8 uses the merchant identifier of the merchant F 142 to send the UR response, via one of the communication interfaces 6, to the merchant F 142, as illustrated by arrow 162. The membership identifier N is extracted from the UR response and used for recognition of the consumer in accordance with the traditional processes employed by the merchant F 142 and its membership system 163.

The URR system 2 sends the UR response to the merchant F 142, as illustrated by arrow 162, via a communication network that is not part of any payment communication network. In an alternate implementation, the URR system 2 may send the UR response back to the acquirer data centre 138, as illustrated by arrow 163, via a communication network that is not part of any payment communication network. For example, the UR response may be sent to the acquirer data centre 138 via the same communication network used by the acquirer data centre 138 to send the UR receipt to the URR system 2. In that alternate implementation, the acquirer data centre 138 may postpone communicating the payment response received from the payment processor data centre 100 until the UR response is received from the URR system 2. For example, responsive to receiving the UR response from the URR system 2, the acquirer data centre 138 may extract the membership identifier N from the UR response and include the membership identifier N in the payment response, which is then communicated via the payment communication networks back to the merchant F 142. In another example, responsive to receiving the UR response from the URR system 2, the acquirer data centre 138 may communicate the payment response together with the UR response via the payment communication networks back to the merchant F 142.

Since the merchant E 140 and the merchant F 142 participate in the UR platform's eco-system, the IIN range table at the point-of-sale device 51 and the IIN range table at the point-of-sale device 156 are arranged so that the point-of-sale devices direct communications associated with UR numbers, such as the UR number X, to the URR system 2. This arrangement of the IIN table at the point-of-sale devices, and any logic and commands implemented at the point-of-sale devices 51, 156 for handling the UR number, is represented schematically as the circle 20. The operation of the point-of-sale devices when receiving a UR number captured from a non-payment token is as described above with respect to FIG. 1. However, this arrangement of the IIN table and operation of the point-of-sale devices is not necessary for the operation of the point-of-sale device 51 as described with respect to FIG. 2-4 and is not necessary for the operation of the point-of-sale device 156 as described with respect to FIG. 2-4.

Third-Party Membership Program Affiliated with Multiple Merchants

FIG. 2-5 illustrates a schematic diagram of two example transactions at two different merchants, the transactions involving different payment tokens presenting different payment numbers associated with different UR numbers, but where the same consumer possesses the different payment tokens.

The AIR MILES® reward program, which is owned and operated by LoyaltyOne, Inc., is an example of a membership program that is affiliated with multiple merchants. A member of the program can earn AIR MILES® reward miles for purchases made at many different merchants including, for example, the restaurant chain Boston Pizza®, the grocery store Metro®, and the crafts store Michaels®.

The Aeroplan® membership program, which is owned and operated by Amia, Inc., is another example of a membership program that is affiliated with multiple merchants. A member of the program can earn Aeroplan® miles for purchases made at many different merchants including, for example, Esso® gas stations, Home Hardware® stores, and Birks® jewelry stores.

In the example of FIG. 2-5, a third-party membership program 164 is affiliated with multiple merchants, including a merchant H 166 and a merchant J 168. Thus the database 4 may contain a listing of identifiers of the multiple merchants affiliated with the third-party membership program 164 and may associate that listing with an identifier of the third-party membership program 164.

The consumer is a member of the third-party membership program 164. Within the third-party membership program 164, the consumer is identified by the membership identifier “T”. In one example, the consumer might seek to accrue loyalty points in the third-party membership program 164 while making a purchase at the merchant H 166, where the merchant H 166 is a restaurant, for example. The consumer might later seek to accrue loyalty points in the third-party membership program 164 while making a purchase at the merchant J 168, where the merchant J 168 is a shoe store, for example.

The consumer possesses the payment token 38 presenting the payment number Y that is associated with the UR number Z, and the payment token 98 presenting the payment number L that is associated with the UR number W.

In the example of FIG. 2-5, the third-party membership program 164, the merchant H 166 and the merchant J 168 all participate in the UR platform's eco-system. The membership identifier T has previously been linked to the UR number Z and to the UR number W within the URR system 2. Moreover the merchant H 166 sends payment receipts to the acquirer data centre 52 and the merchant J 168 sends payment receipts to the acquirer data centre 78.

When the consumer presents the payment token 38 to a token capture device 170 of the merchant H 166, the token capture device 170 captures the payment number Y and provides the payment number Y to a point-of-sale device 172 of the merchant H 166. In accordance with traditional processing of a financial transaction, the point-of-sale device 172 then sends a payment receipt to the acquirer data centre 52, as illustrated by arrow 174, where the payment receipt necessarily contains the payment number Y and an identifier of the merchant H 166. The payment receipt may contain additional items to be described in more detail later. The traditional processing of the financial transaction continues as described above with respect to FIG. 2-1, with communication of the payment receipt and the payment response occurring via payment communication networks, as known in the art. As part of the traditional processing, the acquirer data centre 52 sends the payment receipt to the payment processor data centre 40, as illustrated by arrow 176.

When the payment processor data centre 40 receives the payment receipt from the acquirer data centre 52, the payment processor data centre 40 uses the table 66 of payment numbers and associated UR numbers to retrieve the UR number Z that is associated with the payment number Y. The payment processor data centre 40 then generates and sends a UR receipt to the URR system 2, where the UR receipt contains, at a minimum, the UR number Z and an indication of the membership program for which a membership identifier is needed, for example, the identifier of the merchant H 166. The UR receipt may contain additional items to be described in more detail later. The payment processor data centre 40 sends the UR receipt to the URR system 2, as illustrated by arrow 178, via a communication network that is not part of any payment communication network.

Responsive to receiving the UR receipt via one of the communication interfaces 6, the switching subsystem 8 locates the UR number Z in the database 4. Using the indication of the membership program (in this example, the identifier of the merchant H 166) that was contained in the UR receipt that was received (as illustrated by arrow 178), the switching subsystem 8 looks up the identifier of the third-party membership program 164. Using the identifier of the third-party membership program 164, the switching subsystem 8 retrieves the corresponding membership identifier T that is linked to the UR number Z. The switching subsystem 8 then generates a UR response which contains, at a minimum, the membership identifier T. The UR response may contain additional items to be described in more detail later. An agreement between the UR platform provider and the merchant H 166 may be used to determine whether the UR response is sent. In the example of FIGS. 2-5, the switching subsystem 8 uses the merchant identifier of the merchant H 166 to send the UR response, via one of the communication interfaces 6, to the merchant H 166, as illustrated by arrow 180. The membership identifier T is extracted from the UR response and used for recognition of the consumer in accordance with the traditional processes employed by the merchant H 166 and the third-party membership system 164.

The URR system 2 sends the UR response to the merchant H 166, as illustrated by arrow 180, via a communication network that is not part of any payment communication network. In an alternate implementation, the URR system 2 may send the UR response back to the payment processor data centre 40, as illustrated by arrow 181, via a communication network that is not part of any payment communication network. For example, the UR response may be sent to the payment processor data centre 40 via the same communication network used by the payment processor data centre 40 to send the UR receipt to the URR system 2. In that alternate implementation, the payment processor data centre 40 may postpone communicating the payment response received from the issuer data centre 42 until the UR response is received from the URR system 2. For example, responsive to receiving the UR response from the URR system 2, the payment processor data centre 40 may extract the membership identifier T from the UR response and include the membership identifier T in the payment response, which is then communicated via the payment communication networks back to the acquirer data centre 52 for further communication via the payment communication networks to the merchant H 166. In another example, responsive to receiving the UR response from the URR system 2, the payment processor data centre 40 may communicate the payment response together with the UR response via the payment communication networks back to the acquirer data centre 52 for further communication via the payment communication networks to the merchant H 166.

A similar sequence of events may take place when the payment token 98 is presented at the merchant J 168. When the consumer presents the payment token 98 to a token capture device 182 of the merchant J 168, the token capture device 182 captures the payment number L and provides the payment number L to a point-of-sale device 184 of the merchant J 168. In accordance with traditional processing of a financial transaction, the point-of-sale device 184 then sends a payment receipt to the acquirer data centre 78, as illustrated by arrow 186, where the payment receipt necessarily contains the payment number L and an identifier of the merchant J 168. The payment receipt may contain additional items to be described in more detail later. The traditional processing of the financial transaction continues as described above with respect to FIG. 2-2, with communication of the payment receipt and the payment response occurring via payment communication networks, as known in the art. As part of the traditional processing, the acquirer data centre 78 sends the payment receipt to the payment processor data centre 100, as illustrated by arrow 188, and the payment processor data centre 100 sends the payment receipt to the issuer data centre 102, as illustrated by arrow 190.

When the issuer data centre 102 receives the payment receipt from the payment processor data centre 100, the issuer data centre 102 uses the table 116 of payment numbers and associated UR numbers to retrieve the UR number W that is associated with the payment number L. The issuer data centre 102 then generates and sends a UR receipt to the URR system 2, where the UR receipt contains, at a minimum, the UR number W and an indication of the membership program for which a membership identifier is needed, for example, the identifier of the merchant J 168. The UR receipt may contain additional items to be described in more detail later. The issuer data centre 102 sends the UR receipt to the URR system 2, as illustrated by arrow 192, via a communication network that is not part of any payment communication network.

Responsive to receiving the UR receipt via one of the communication interfaces 6, the switching subsystem 8 locates the UR number W in the database 4. Using the indication of the membership program (in this example, the identifier of the merchant J 168) that was contained in the UR receipt that was received (as illustrated by arrow 192), the switching subsystem 8 looks up the identifier of the third-party membership program 164. Using the identifier of the third-party membership program 164, the switching subsystem 8 retrieves the corresponding membership identifier T that is linked to the UR number W. The switching subsystem 8 then generates a UR response which contains, at a minimum, the membership identifier T. The UR response may contain additional items to be described in more detail later. An agreement between the UR platform provider and the merchant J 168 may be used to determine whether the UR response is sent. In the example of FIGS. 2-5, the switching subsystem 8 uses the merchant identifier of the merchant J 168 to send the UR response, via one of the communication interfaces 6, to the merchant J 168, as illustrated by arrow 194. The membership identifier T is extracted from the UR response and used for recognition of the consumer in accordance with the traditional processes employed by the merchant J 168 and the third-party membership system 164.

The URR system 2 sends the UR response to the merchant J 168, as illustrated by arrow 194, via a communication network that is not part of any payment communication network. In an alternate implementation, the URR system 2 may send the UR response back to the issuer data centre 102, as illustrated by arrow 195, via a communication network that is not part of any payment communication network. For example, the UR response may be sent to the issuer data centre 102 via the same communication network used by the issuer data centre 102 to send the UR receipt to the URR system 2. In that alternate implementation, the issuer data centre 102 may postpone communicating the payment response it generates until the UR response is received from the URR system 2. For example, responsive to receiving the UR response from the URR system 2, the issuer data centre 102 may extract the membership identifier T from the UR response and include the membership identifier T in the payment response, which is then communicated via the payment communication networks back to the payment processor data centre 100 for further communication via the payment communication networks to the acquirer data centre 78 and then to the merchant J 168. In another example, responsive to receiving the UR response from the URR system 2, the issuer data centre 102 may communicate the payment response together with the UR response via the payment communication networks back to the payment processor data centre 100 for further communication via the payment communication networks to the acquirer data centre 78 and then to the merchant J 168.

Although not explicitly illustrated in FIGS. 2-1, 2-2, 2-3, 2-4, and 2-5, communication of the UR receipt from the payment transaction partner data centre to the URR system 2 occurs over communication networks using a network service agreed upon between the payment transaction partner data centre and the UR platform provider. The payment transaction partner data centres address the UR receipts to an Internet Protocol (IP) address of the URR system 2. Furthermore, communication of the UR response from the URR system 2 (to the merchant, to the membership program, to the point-of-sale device, or elsewhere as agreed upon) occurs over communication networks using a network service agreed upon between the URR system 2 and the recipient of the UR response. Examples of network services include virtual private networking (VPN), MPLS, and frame relay. Authentication and encryption techniques may be employed for the communication of the UR receipt and the communication of the UR response. If the UR response is received by the payment transaction partner data centre from the URR system 2, and then the payment transaction partner data centre communicates the UR response (or the membership identifier extracted therefrom) via payment communication networks, fees may need to be paid to the payment processor and/or to the acquirer for the privilege of using the payment communication networks. If the UR response is communicated from the URR system 2 solely via communication networks that are not part of any payment communication network, then payment of such fees can be avoided.

FIGS. 2-1, 2-2, 2-3, 2-4, and 2-5 illustrate transactions involving payment. It is contemplated that the payment token 38 and/or the payment token 98 is presented solely to effect recognition of the consumer without any payment. This may be implemented by creating a financial transaction of zero value, or by bypassing financial transaction processing steps that occur after the payment transaction partner data centre has received the payment receipt (i.e., bypassing arrows 58, 60, 62, 64 and 84, 86, 88 and 90 for FIG. 2-1; bypassing arrows 110, 112, 114 and 128, 130, 132 for FIG. 2-2; bypassing arrows 58, 60, 62, 64 and 128, 130, 132 for FIG. 2-3; bypassing unreferenced arrows for FIG. 2-4 and for FIG. 2-5), or in any other suitable manner.

UR Account of Consumer has One or More UR Numbers

FIG. 3 illustrates a conceptual diagram of an example UR account 200 of a consumer. The UR account 200 may be understood conceptually as connecting consumer identity information 201 with at least one UR number. The consumer identity information 201 may include one or more of a consumer's name, mailing address, telephone number, email address, fax number, gender, age, occupation, salary, ethnicity, and the like.

In the example of FIG. 3, the UR account 200 includes three UR numbers: UR number Z 203, UR number X 205, and UR number W 207.

The UR number Z 203 is associated with a payment number Y 206, as illustrated by line 208. That is, a payment transaction partner (a payment processor or an issuer or an acquirer) affiliated with the payment number Y 206 has partnered with the UR platform provider, and accordingly its data centre maintains a table of payment numbers and associated UR numbers. For example, the payment number Y is a credit card number.

The UR number Z 203 is linked to the membership identifiers P 210, Q 212, R 214 and S 216, as illustrated by lines 218. The membership identifier P 210 corresponds to the merchant A, which is identified by a merchant identifier 220. The membership identifier Q 212 corresponds to the merchant B, which is identified by a merchant identifier 222. The membership identifier R 214 corresponds to the merchant C, which is identified by a merchant identifier 224. The membership identifier S 216 corresponds to the merchant D, which is identified by a merchant identifier 226.

The UR number X 205 is linked to membership identifiers X 228 and M 230, as illustrated by lines 232. The membership identifier X 228 corresponds to a merchant G, which is identified by a merchant identifier 234. The membership identifier M 230 corresponds to the merchant E, which is identified by a merchant identifier 236. In this example, the UR number X 205 serves as the membership identifier X 228. This could occur, for example, where the merchant G agrees to issue tokens presenting UR numbers to consumers joining the merchant's membership system.

The UR number W 207 is associated with a payment number L 238, as illustrated by line 240. That is, a payment transaction partner (a payment processor or an issuer or an acquirer) affiliated with the payment number L 238 has partnered with the UR platform provider, and accordingly its data centre maintains a table of payment numbers and associated UR numbers. For example, the payment number L is a debit card number.

The UR number W 207 is linked to membership identifiers N 242 and T 244, as illustrated by lines 246. The membership identifier N 242 corresponds to the merchant F, which is identified by a merchant identifier 248. The membership identifier T 244 corresponds to a common membership program K, which is identified by a merchant identifier 250.

In addition to the linking represented by lines 218, 232 and 246, there is automatically additional linking by virtue of the UR numbers Z 203, X 205 and W 207 belonging to the same UR account 200. That is, because the UR numbers Z 203, X 205 and W 207 are connected with the same consumer identity information 201, the membership identifiers X 228 and M 230 are automatically linked to the UR number Z 203 and to the UR number W 207. Similarly, the membership identifiers P 210, Q 212, R 214 and S 216 are automatically linked to the UR number X 205 and to the UR number W 207. Similarly, the membership identifiers N 242 and T 244 are automatically linked to the UR number Z 203 and to the UR number X 205. This additional linking is illustrated conceptually by lines 252.

Many scenarios are possible within the example framework illustrated in FIG. 3.

In one example, in response to presenting the payment card number Y 206 at the merchant E, the URR system provides the membership identifier M 230 to a membership system of the merchant E. This result is a consequence of (i) the payment number Y 206 being associated with the UR number Z 203; (ii) the UR number Z 203 and the UR number X 205 belonging to the same UR account 200 (i.e., connected with the same consumer identity information 201); and (iii) the UR number X 205 being linked to the membership identifier M 230 for merchant E's membership program.

In another example, in response to presenting the payment number L 238 at the merchant A, the URR system provides the membership identifier P 210 to the merchant A. This result is a consequence of (i) the payment number L 238 being associated with the UR number W 207; (ii) the UR number W 207 and the UR number Z 203 belonging to the same UR account 200 (i.e., connected with the same consumer identity information 201); and (iii) the membership identifier P 210 being the membership identifier for merchant A's membership program.

In yet another example, in response to presenting the membership card for merchant G's membership program at the merchant F, the URR system provides the membership identifier N 242 to the merchant F. This result is a consequence of (i) the membership identifier X 228 being linked to (in this case, identical to) the UR number X 205; (ii) the UR number X 205 and the UR number W 207 belonging to the same UR account 200 (i.e., connected with the same consumer identity information 201); and (iii) the membership identifier N 242 being the membership identifier for merchant F's membership program.

The consumer for which the account 200 is maintained has the choice to use any of her three tokens (the non-payment token 10 presenting the UR number X, the payment token 38 presenting the payment number Y, and the payment token 98 presenting the payment number L) in order to be recognized by the UR platform. This plethora of tokens and UR numbers is meant to illustrate the comprehensiveness, breadth and flexibility of the UR platform. Some consumers will have only a single UR number in their UR account and may have one or more non-payment tokens presenting that single UR number. Other consumers will have only a single UR number in their UR account and may have one or more payment tokens presenting a single payment number associated to that single UR number. Yet other consumers will have two or more UR numbers in their UR account, similar to the consumer for which the account 200 is maintained.

Transactions Involving Non-Payment Token Presenting UR Number

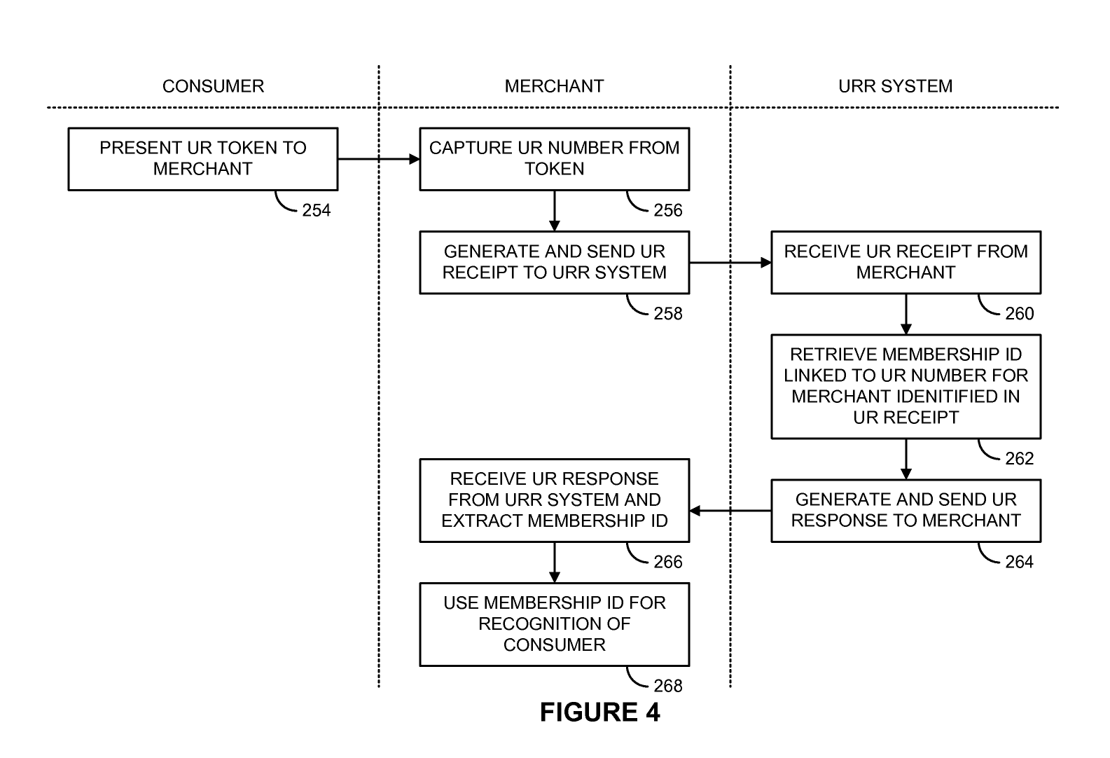

FIG. 4 illustrates example methods for a consumer, for a merchant, and for a URR system. The methods illustrated in FIG. 4 are for use with a non-payment token (“UR token”) presenting a UR number that is linked to a membership identifier of the merchant's membership program. An example of the UR token is the token 10 in FIG. 1. Examples of the merchant include the merchant A 12 or the merchant B 14. An example of the URR system is the URR system 2.

The methods of FIG. 4 may be performed as part of a transaction that includes a payment to the merchant. For example, in addition to presenting the UR token, the consumer may also make a purchase using cash, a gift card, or a payment card that is not associated with a UR number.

At 254, the consumer presents the UR token to the merchant. Using a token capture device, such as the token capture device 16 or 28 in FIG. 1, the merchant captures the UR number from the token, as illustrated at 256. By comparing the IIN of the captured UR number to the IIN range table at the point-of-sale device, such as the point-of-sale device 18 or 30 in FIG. 1, the merchant identifies that a UR receipt should be sent to the URR system. Accordingly, at 258, the merchant generates and sends a UR receipt to the URR system. As described previously, the UR receipt contains, at a minimum, the UR number and an indication of the membership program for which a membership identifier is needed, for example, the merchant identifier. Additionally, the UR receipt may contain a transaction identifier which identifies the nature of the transaction, for example, whether the transaction is a purchase, a request for access, a request for loyalty points redemption, or some other transaction. The UR receipt may also include a transmission identifier which identifies, for example, the time of the transaction or an identification number of the transaction. Both the transmission identifier and the transaction identifier may subsequently be used for reconciliation of the membership identifier with the captured UR number, as will be described later. The UR receipt may contain additional items. For example, where the UR receipt is formatted in accordance with the ISO 0600/0601 administrative data message format, the UR receipt may include any of the items listed in the Appendix A.

At 260, the URR system receives the UR receipt from the merchant. Upon locating within the UR database the UR number that was contained in the UR receipt, the URR system retrieves a membership identifier linked to the UR number, where the membership identifier corresponds to the merchant identified in the UR receipt (or to a membership program with which the merchant identified in the UR receipt is affiliated). For example, after receiving the UR receipt as illustrated at 22 in FIG. 1, the URR system 2 retrieves the membership identifier P that is linked to the UR number X, where the membership identifier P corresponds to the merchant A that was identified in the UR receipt. Retrieval of the membership identifier is illustrated at 262. The URR system then generates a UR response which contains, at a minimum, the membership identifier that was retrieved at 262. Additionally, the UR response may contain the merchant identifier, the transaction identifier, and the transmission identifier. The UR response may include additional items. For example, where the UR response is formatted in accordance with the ISO 610 administrative data message format, the UR response may include one or more of the items listed in the Appendix A.

Using the indication of the membership program (for example, the merchant identifier) contained in the UR receipt received at 260, the URR system sends the UR response to the merchant, as illustrated at 264. Alternatively, the URR system may send the UR response to a membership system of the merchant, such as the membership system 24 or 36 in FIG. 1, or to another entity, such as a third party membership system. As described previously, an agreement between the merchant and UR platform provider may be used to determine where the UR response is sent by the URR system.

The merchant (or, alternatively, the other entity agreed upon by the merchant and the UR platform provider) receives the UR response from the URR system and extracts the membership identifier, as illustrated at 266. The membership identifier is then used for recognition of the consumer in accordance with the traditional processes employed by the merchant or the third party entity, for example, to grant access, to award points, to redeem points, and the like, as illustrated at 268.

In the event that the UR response contains the transaction identifier or the transmission identifier or both, these items may be used to reconcile the membership identifier contained in the UR response with the UR number that was captured by the merchant at 256. For example, the merchant may compare the transaction identifier and the transmission identifier contained the UR response to records of transaction identifiers and transmission identifiers in order to confirm that the UR response received at 266 contains a membership identifier that corresponds to the UR number captured at 256. The UR response may contain alternative or additional items that are used for this kind of reconciliation.

Transactions involving payment token presenting payment number associated with UR number

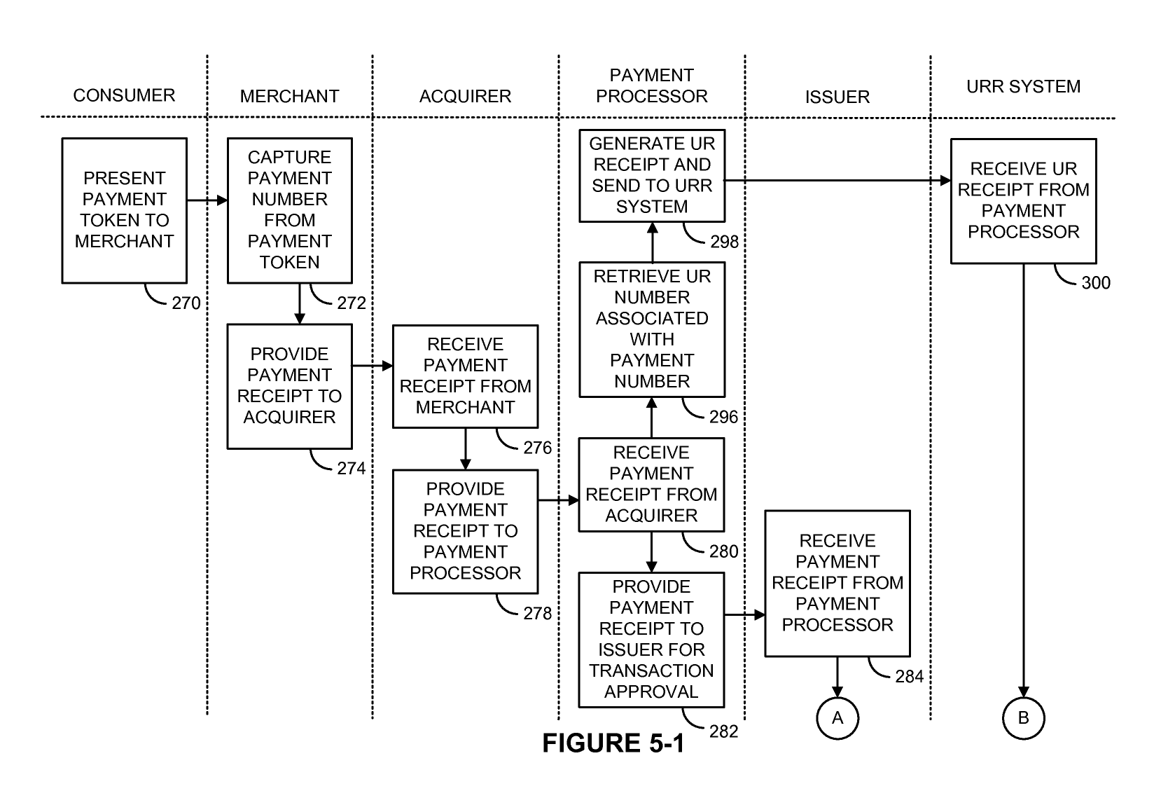

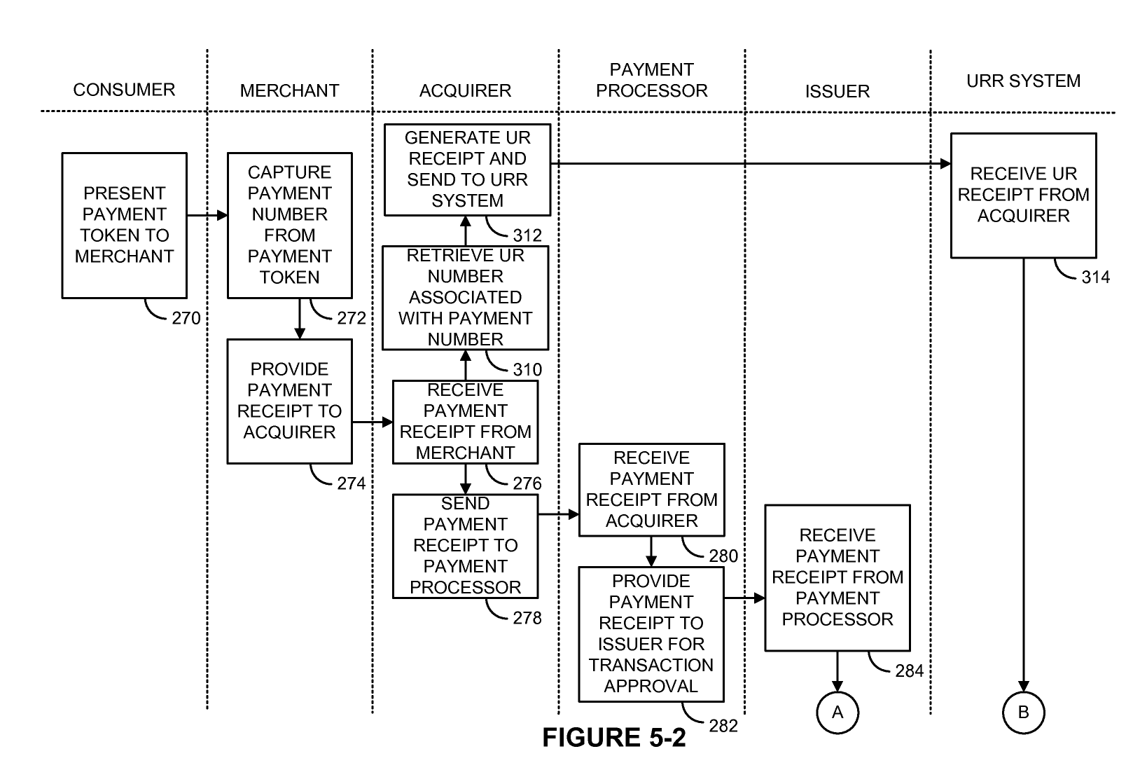

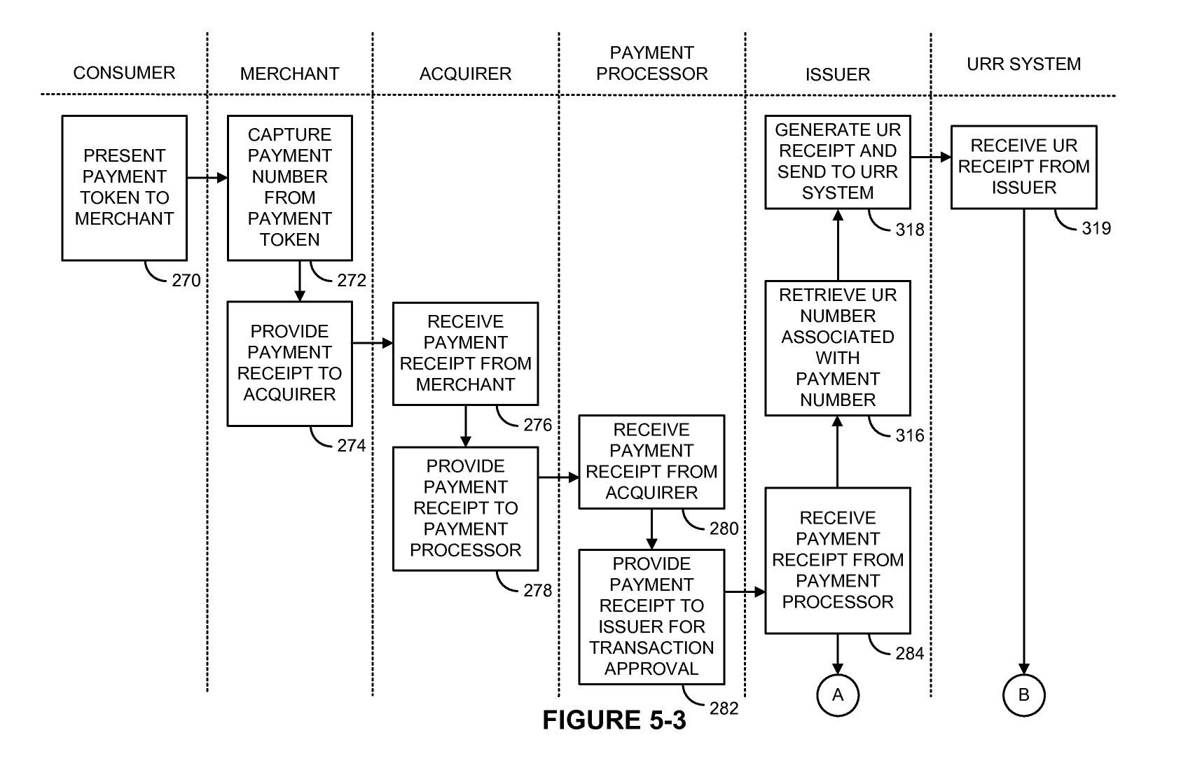

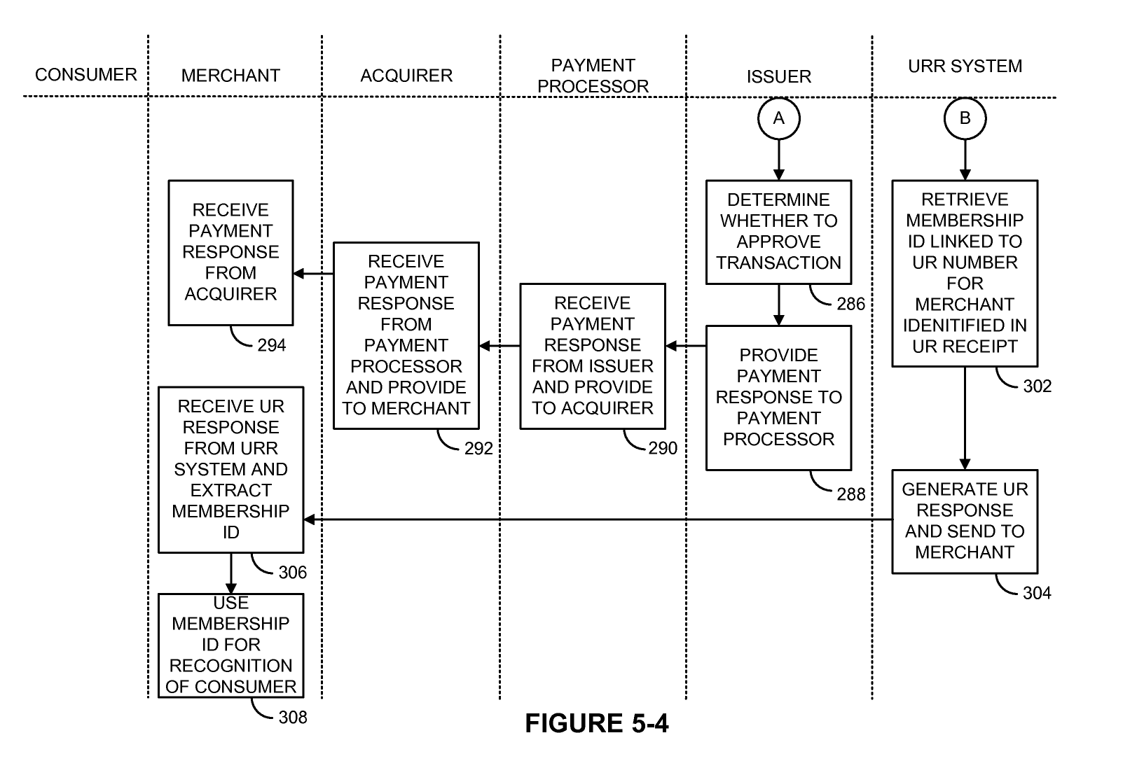

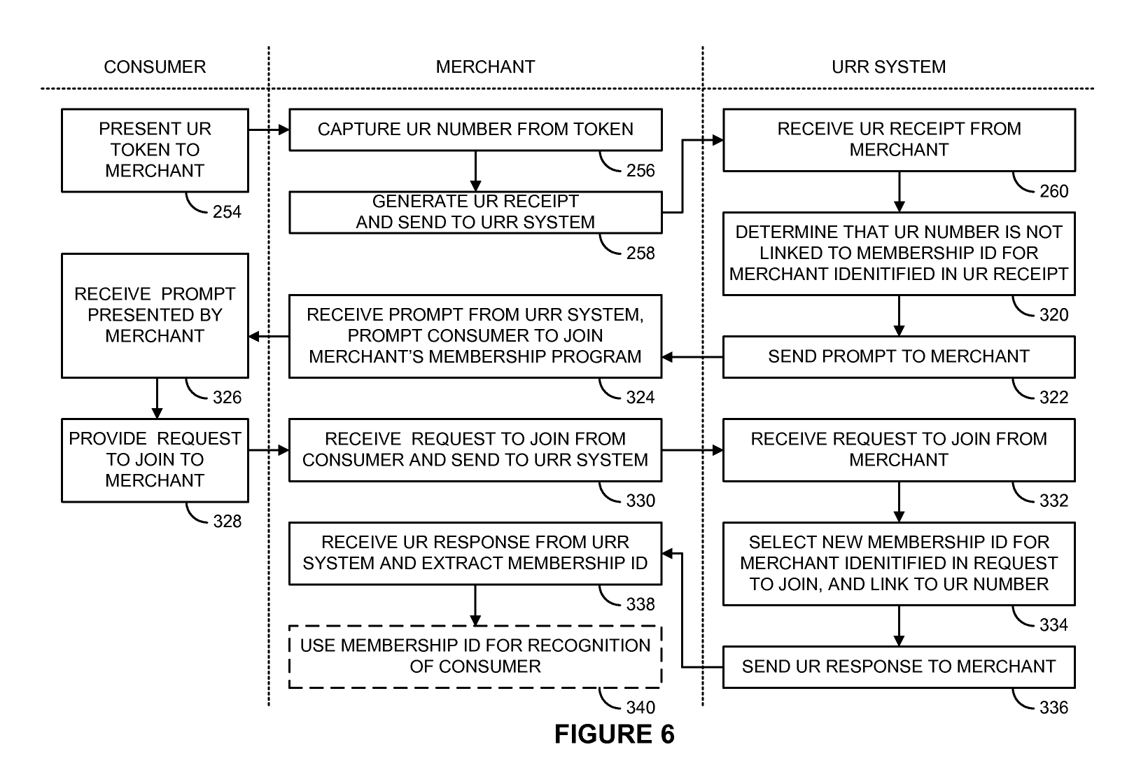

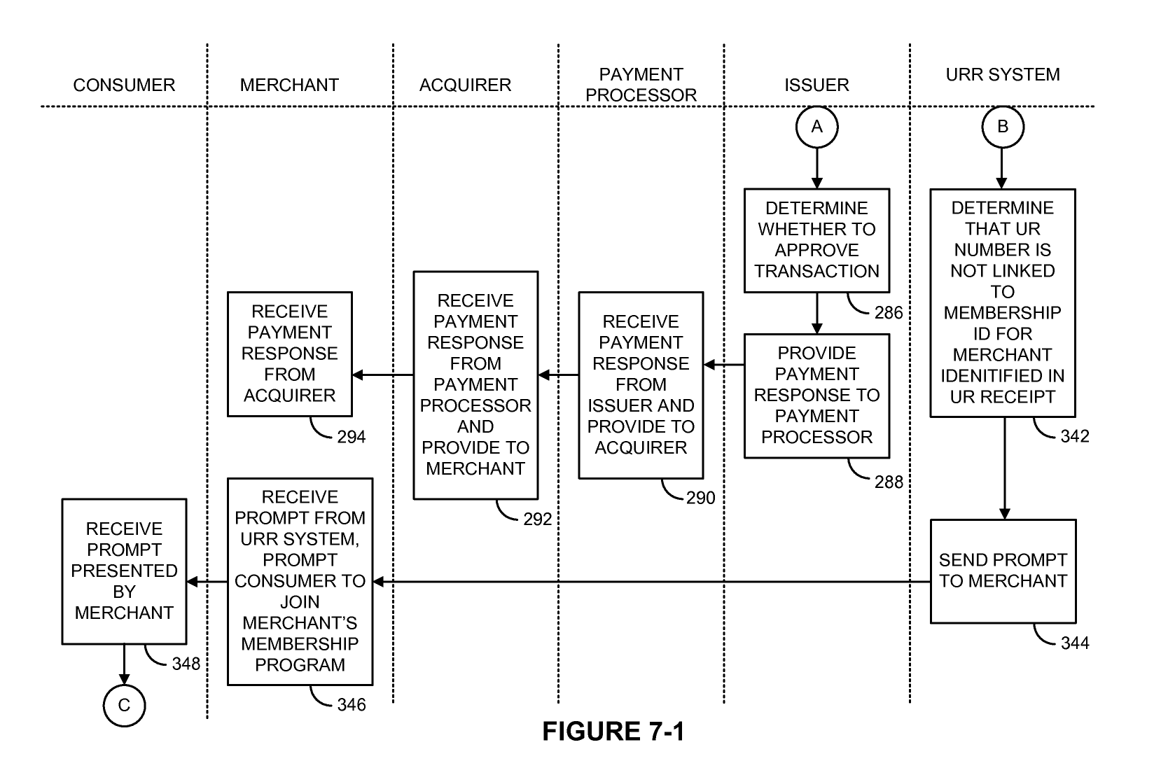

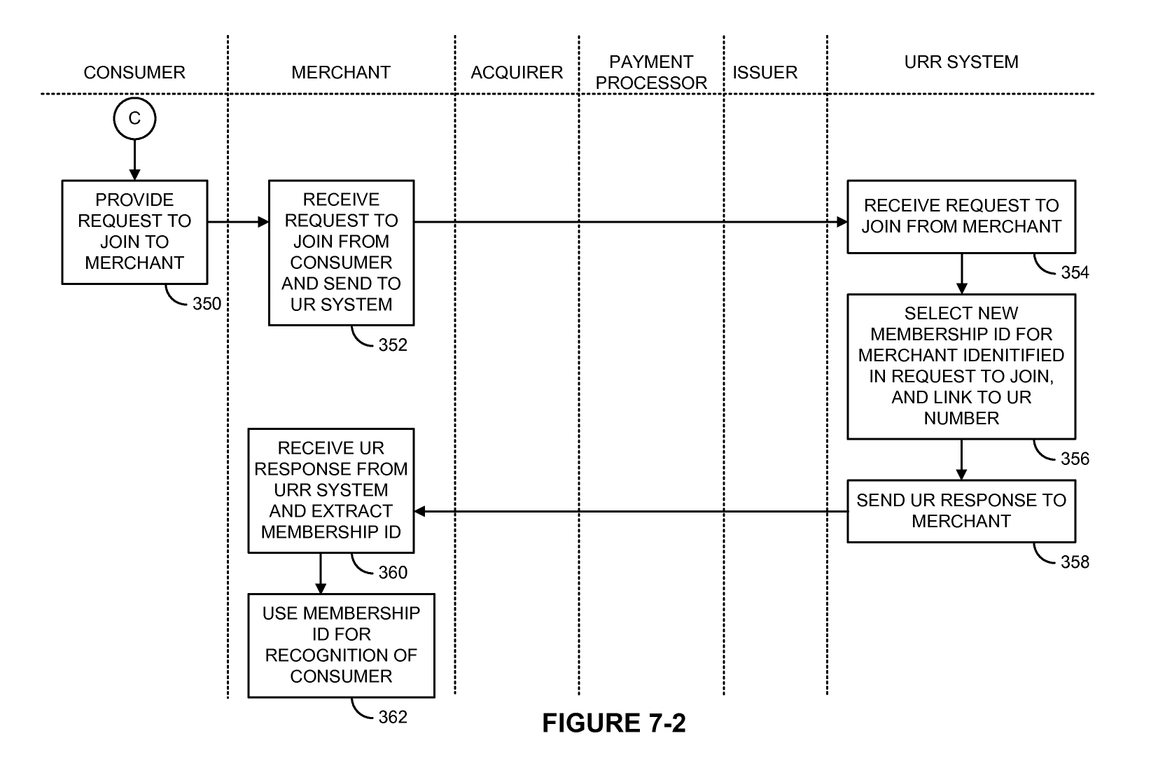

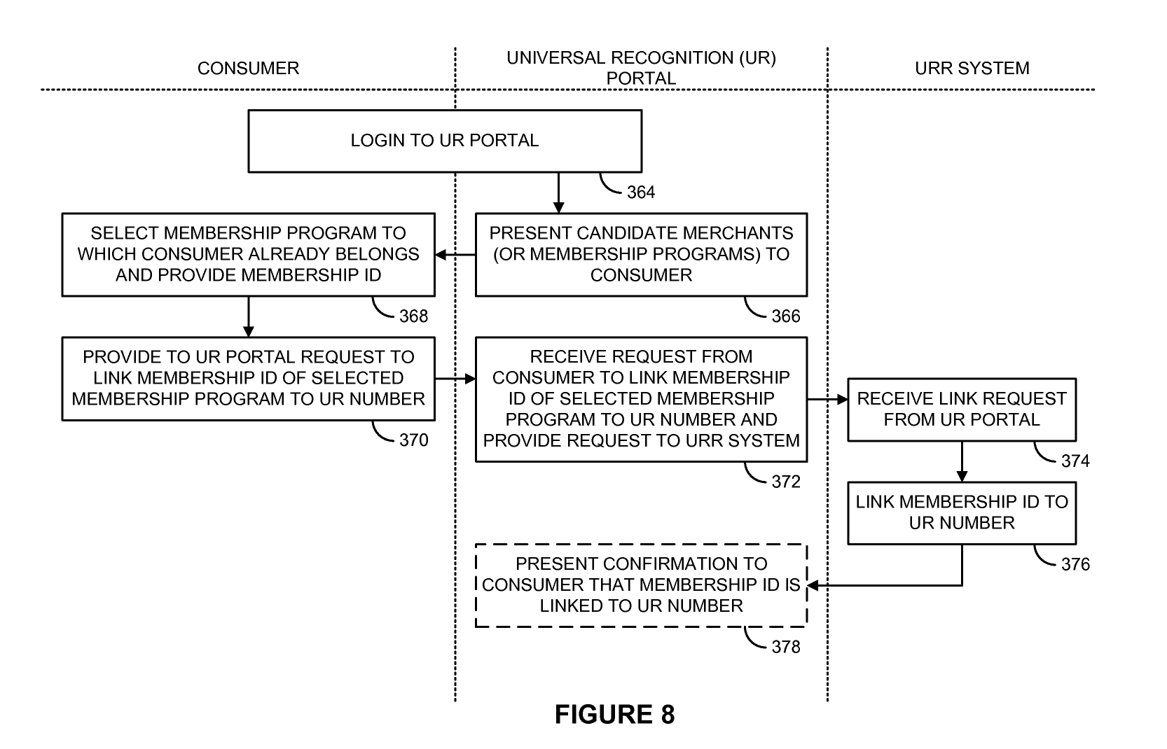

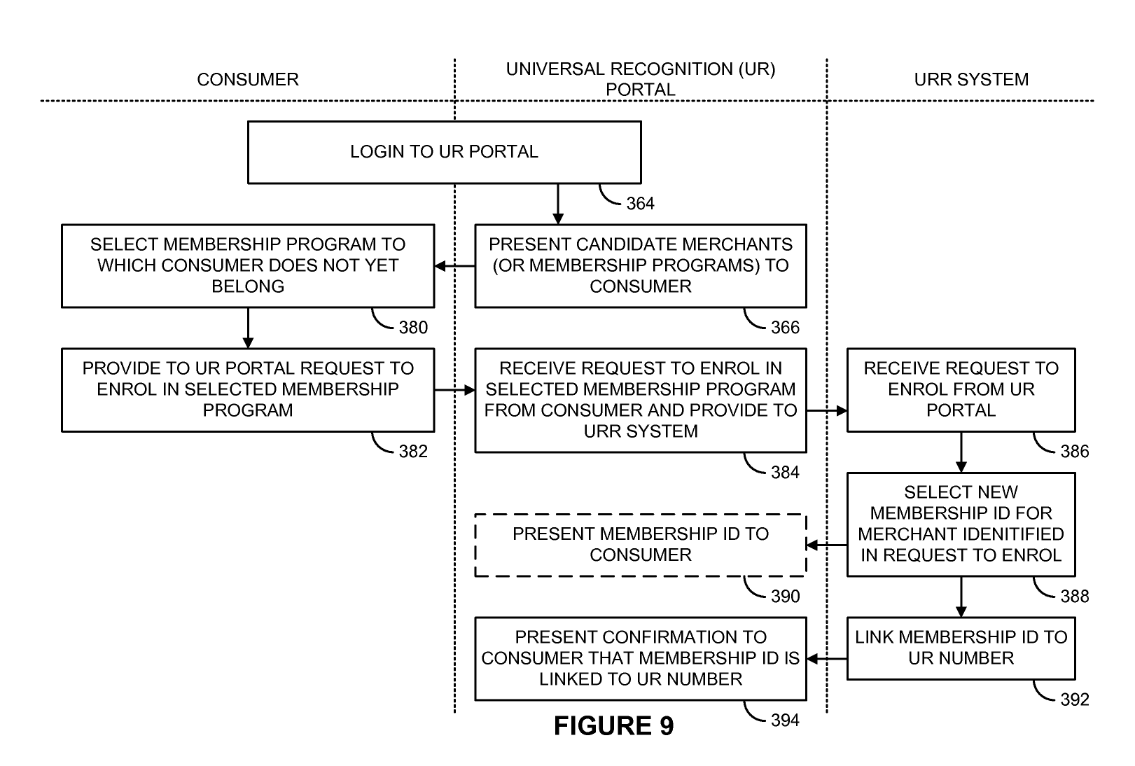

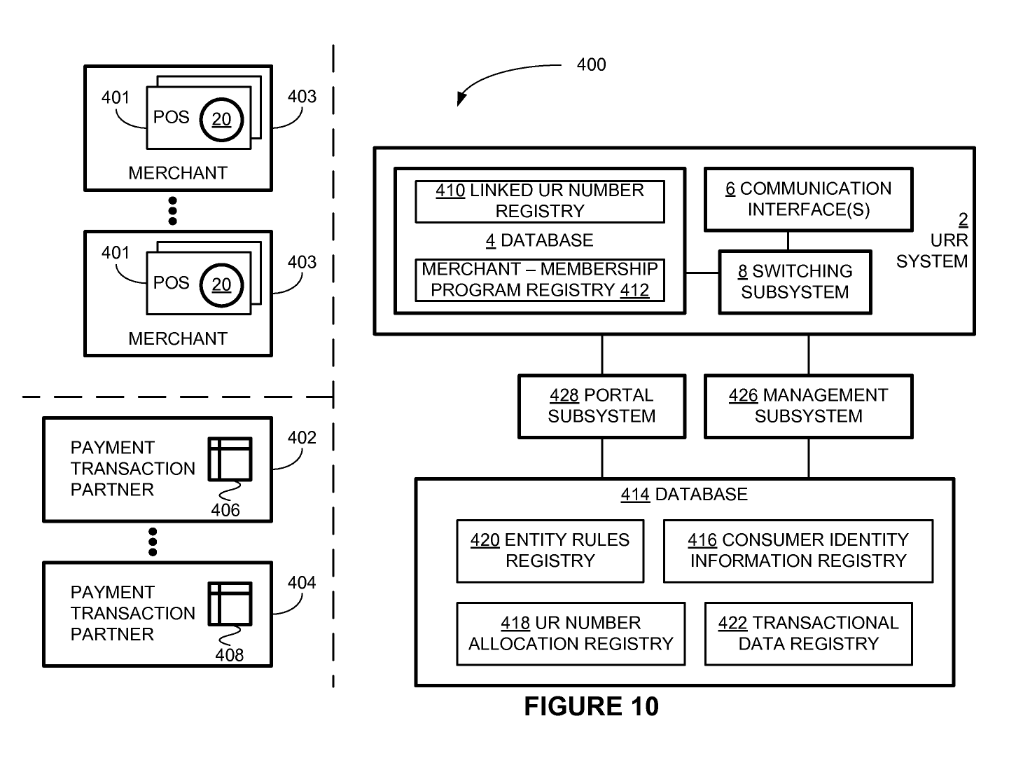

FIGS. 5-1, 5-2, 5-3 and 5-4 illustrate example methods for a consumer, for a merchant, for an acquirer data centre, for a payment processor data centre, for an issuer data centre and for a URR system. The methods illustrated in FIGS. 5-1, 5-2, 5-3 and 5-4 are for use with a payment token presenting a payment number associated with a UR number that is linked to a membership identifier of the merchant's membership program. The consumer presents the payment token to effect payment for goods or services as part of a transaction. The actions illustrated in FIG. 5-4 may be performed subsequently to the actions illustrated in any one of FIGS. 5-1, 5-2, and 5-3. FIGS. 5-1, 5-2 and 5-3 differ from one another in terms of the entity that performs the retrieval and routing of the UR number. Specifically, in the example methods illustrated in the combination of FIGS. 5-1 and 5-4, the retrieval and routing of the UR number is performed by the payment processor data centre. In the example methods illustrated in the combination of FIGS. 5-2 and 5-4, the retrieval and routing of the UR number is performed by the acquirer data centre. In the example methods illustrated in the combination of FIGS. 5-3 and 5-4, the retrieval and routing of the UR number is performed by the issuer data centre. An example of the payment token is the token 38 in FIG. 2. Examples of the merchant include the merchant C 44 or the merchant D 46. An example of the URR system is the URR system 2.

As illustrated in FIGS. 5-1, 5-2 and 5-3, at 270, the consumer presents the payment token to the merchant. Using a token capture device, such as the token capture device 48 or 74 in FIG. 2-1, the payment number is captured from the token and provided to a point-of-sale device of the merchant as illustrated at 272, where an example of the point-of-sale device is the point-of-sale device 50 or 76 in FIG. 2-1. In accordance with traditional processing of a financial transaction, a payment receipt is sent to the merchant's acquirer data centre, as illustrated at 274. As described previously, the payment receipt necessarily contains the payment number of the payment token and the merchant identifier. The payment receipt also necessarily contains any information required by the acquirer data centre, payment processor data centre and issuer data centre in order to process the financial transaction. Such information may include a basket price, an expiry date of the payment number, identity of a holder of the payment number, and the link. The basket price is the amount of money involved in the financial transaction. For example, the basket price may be the cost of all items and/or services being purchased, inclusive of any taxes and fees, and exclusive of discounts. Additionally, the payment receipt may contain a transaction identifier and a transmission identifier which may subsequently be used for reconciliation of the membership identifier with the captured payment number, as will be described later. The payment receipt may contain additional items. For example, where the payment receipt is formatted in accordance with the ISO 0100 administrative data message format, the payment receipt may include any of the items listed in the Appendix B.

In accordance with traditional processing of a financial transaction, the acquirer data centre, at 276, receives the payment receipt from the merchant, and at 278, processes the payment receipt and sends the processed payment receipt to the appropriate payment processor data centre, such as the payment processor data centre 40 in FIG. 2-1, where the payment processor works with the issuer of the payment number.

At 280, the payment processor data centre receives the processed payment receipt from the acquirer data centre. At 282, the payment processor data centre further processes the payment receipt and sends the further processed payment receipt to an issuer data centre, such as the issuer data centre 42, where the issuer is the issuer of the payment number. At 284, the issuer data centre receives the further processed payment receipt from the payment processor data centre.

Turning to FIG. 5-4, the issuer data centre determines at 286 whether to approve or to deny the transaction. At 288, the issuer data centre sends a payment response back to the payment processor data centre, where the payment response contains an indication of whether the transaction was approved or denied. The payment response may contain additional items. For example, where the payment response is formatted in accordance with the ISO 0110 administrative data message format, the payment response may include any of the items listed in the Appendix B. At 290, the payment processor data centre receives the payment response and sends it to the acquirer data centre. At 292, the acquirer data centre receives the payment response and sends it to the merchant. At 294, the merchant's point-of-sale device receives the payment response. In accordance with the contents of the payment response, the merchant may complete the transaction or may provide the consumer with information regarding why the transaction was denied, for example.

The set of actions performed by the acquirer data centre, payment processor data centre and issuer data centre at 276, 278, 280, 282, 284, 286, 288, 290 and 292 may be described as processing of the financial transaction. During the processing of the financial transaction, the payment receipt or the payment response or both may be altered, for example, by changing the value of certain data elements. In one example, at approximately the same time as the financial transaction is being processed, the relevant membership identifier is retrieved and provided to the merchant or to some other entity agreed upon by the merchant and UR platform provider. In another example, retrieval of the relevant membership identifier and provision to the merchant or to some other entity agreed upon by the merchant and UR platform provider may be performed in batches, thus not in real-time with respect to the processing of the financial transaction.

In the example method of FIG. 5-1, the payment processor has partnered with the UR platform provider such that payment processor data centre maintains a table of associations between payment numbers and UR numbers, in which each payment number in the table is associated with a single UR number in the table.

At 296, the payment processor data centre uses the payment number received from the acquirer data centre at 280 to retrieve the associated UR number from the table. From the IIN of the retrieved UR number, the payment processor data centre identifies that a UR receipt should be sent to the URR system. Accordingly, at 298, the payment processor data centre generates and sends a UR receipt to the URR system. As described previously, the UR receipt contains, at a minimum, the UR number and an indication of the membership program for which a membership identifier is needed, for example, the merchant identifier. Additionally, the UR receipt may contain a transaction identifier, a transmission identifier, or both, where these items may subsequently be used for reconciliation of the membership identifier with the payment number that was captured at 272, as will be described later. The UR receipt may contain additional items. For example, where the UR receipt is formatted in accordance with the ISO 0100 administrative data message format, the UR receipt may include any of the items listed in the Appendix C. Importantly, the UR receipt does not include the payment number. That is, the payment processor data centre does not share payment numbers with the URR system, thereby maintaining the security of the financial transaction.

At 300, the URR system receives the UR receipt from the payment processor data centre. Turning back to FIG. 5-4, upon locating within the UR database the UR number that was contained in the UR receipt, the URR system retrieves a membership identifier linked to the UR number, where the membership identifier corresponds to the merchant identified in the UR receipt (or to a membership program with which the merchant identified in the UR receipt is affiliated). For example, after receiving the UR receipt from the payment processor data centre 40 as illustrated by arrow 68 in FIG. 2-1, the URR system 2 retrieves the membership identifier R that is linked to the UR number Z, where the membership identifier R corresponds to the merchant C that was identified in the UR receipt. Retrieval of the membership identifier is illustrated at 302. The URR system may then generate a UR response which contains, at a minimum, the membership identifier that was retrieved at 302. Additionally, the UR response may contain the merchant identifier, the transaction identifier, and the transmission identifier. The UR response may include additional items. For example, where the UR response is formatted in accordance with the ISO 0110 administrative data message format, the UR response may include one or more of the items listed in the Appendix C.

Using the indication of the membership program (for example, the merchant identifier) contained in the UR receipt received at 300, the URR system sends the UR response to the merchant, as illustrated at 304. Alternatively, the URR system may send the UR response to a membership system of the merchant, such as the membership system 70 or 96 in FIG. 2-1, or to another entity, such as a third party membership system. As described previously, an agreement between the merchant and UR platform provider may be used to determine where the UR response is sent by the URR system.

The merchant (or, alternatively, the other entity agreed upon by the merchant and the UR platform provider) receives the UR response from the URR system and extracts the membership identifier, as illustrated at 306. The membership identifier may then, at 308, be used for recognition of the consumer in accordance with the traditional processes employed by the merchant or the third party entity, for example, to grant access, to award points, to redeem points, and the like. How the merchant or affiliated membership system uses the membership identifier may depend on whether the payment response received at 294 included an indication that the transaction was approved. In one example, if the transaction was not approved, the merchant or affiliated membership system may not allow the consumer to accrue any loyalty points. In another example, if the transaction is approved, the merchant may optionally print the membership identifier on the payment receipt, together, for example, with the number of loyalty points accrued with the current purchase.

In the event that the UR response contains the transaction identifier or the transmission identifier or both, these items may be used to reconcile the membership identifier contained in the UR response with the payment number that was captured by the merchant at 272. For example, the merchant may compare the transaction identifier and the transmission identifier contained the UR response to records of transaction identifiers and transmission identifiers in order to confirm that the UR response received at 306 contains a membership identifier that corresponds to the payment number captured at 272. The UR response may contain alternative or additional items that are used for this kind of reconciliation.

As an alternative to the payment processor partnering with the UR platform provider, as illustrated in FIG. 5-1, it is contemplated that the acquirer may be partnered with the UR platform provider, as illustrated in FIG. 5-2. In this case, the acquirer data centre would maintain the table of payment numbers and associated UR numbers. Upon receipt of the payment receipt from the merchant at 276, the acquirer data centre uses the payment number to retrieve the associated UR number from the table, as illustrated at 310. From the IIN of the retrieved UR number, the acquirer data centre then identifies that a UR receipt should be sent to the URR system. Accordingly, the acquirer data centre generates a UR receipt and sends the UR receipt to the URR system, as illustrated at 312. Once the URR system receives the UR receipt from the acquirer data centre at 314, the URR system and the merchant is able to proceed as described previously with respect to FIG. 5-4. That is, the URR system retrieves the membership identifier as illustrated at 302, generates a UR response, and sends the UR response to the merchant (or to another entity agreed upon by the merchant and the UR platform provider), as illustrated at 304. The merchant (or, alternatively, the other entity agreed upon by the merchant and the UR platform provider) receives the UR response from the URR system and extracts the membership identifier, as illustrated at 306. The membership identifier may then, at 308, be used for recognition of the consumer. FIG. 2-4 illustrates an example in which an acquirer is partnered with the UR platform provider. After receiving the UR receipt from the acquirer data centre 138 as illustrated by arrow 148 in FIG. 2-4, the URR system 2 retrieves the membership identifier M that is linked to the UR number Z, where the membership identifier M corresponds to the merchant E that was identified in the UR receipt.

As a further alternative to the payment processor or the acquirer partnering with the UR platform provider, as illustrated in FIGS. 5-1 and 5-2, respectively, it is contemplated that the issuer may be partnered with the UR platform provider, as illustrated in FIG. 5-3. In this case, the issuer data centre would maintain the table of payment numbers and associated UR numbers. Upon receipt of the payment receipt from the payment processor data centre at 284, the issuer data centre uses the payment number to retrieve the associated UR number from the table, as illustrated at 316. From the IIN of the retrieved UR number, the issuer data centre then identifies that a UR receipt should be sent to the URR system. Accordingly, the issuer data centre generates a UR receipt and sends the UR receipt to the URR system, as illustrated at 318. Once the URR system receives the UR receipt from the issuer data centre at 319, the URR system and the merchant is able to proceed as described previously with respect to FIG. 5-4. That is, the URR system retrieves the membership identifier as illustrated at 302, generates a UR response, and sends the UR response to the merchant (or to another entity agreed upon by the merchant and the UR platform provider), as illustrated at 304. The merchant (or, alternatively, the other entity agreed upon by the merchant and the UR platform provider) receives the UR response from the URR system and extracts the membership identifier, as illustrated at 306. The membership identifier may then, at 308, be used for recognition of the consumer. FIG. 2-2 illustrates an example in which the issuer data centre 102 is partnered with the UR platform provider. After receiving the UR receipt from the issuer data centre 102 as illustrated by arrow 118 in FIG. 2-2, the URR system 2 retrieves the membership identifier R that is linked to the UR number W, where the membership identifier R corresponds to the merchant C that was identified in the UR receipt.

Join Membership Program During Transaction Involving Non-Payment Token Presenting UR Number

FIG. 6 illustrates example methods for a consumer, for a merchant, and for a URR system. The methods illustrated in FIG. 6 are for use with a non-payment token presenting a UR number that is not linked to a membership identifier of the merchant's membership program. The methods of FIG. 6 might be performed, for example, when a consumer is not yet a member of a merchant's membership program, but wishes to join the membership program while making a transaction at a point-of-sale device.

The token capture process may proceed as described with respect to FIG. 4. That is, at 254 the consumer presents the UR token to the merchant. Using a token capture device, the merchant captures the UR number from the token, as illustrated at 256. By comparing the IIN of the captured UR number to the IIN range table at the point-of-sale device, the merchant identifies that a UR receipt should be sent to the URR system. Accordingly, at 258, the merchant generates and sends a UR receipt to URR system, where the UR receipt contains, at a minimum, the UR number and an indication of the membership program for which a membership identifier is needed, for example, the merchant identifier.

At 260, the URR system receives the UR receipt from the merchant. However, instead of the URR system retrieving a membership identifier, as illustrated at 262, the URR system instead determines at 320 that the UR number is not linked to a membership identifier for the merchant identified in the UR receipt. For example, after locating the UR number in the UR database, the URR system is unable to locate any membership identifier that is linked to the UR number and corresponds to the merchant.

In response to making the determination at 320 that the consumer has not yet joined the merchant's membership program, the UR system sends a prompt to the merchant prompting the consumer to join the merchant's membership program, as illustrated at 322. In one example, the prompt may simply be an error data message, which the merchant will interpret as an indication that the consumer does not have a membership identifier for the merchant's membership program.

Responsive to receiving the prompt, the merchant may prompt the consumer to join the merchant's membership program, as illustrated at 324. For example, a display screen at the point-of-sale device may display “Not in Loyalty Program. Want to Join Now . . . ?” or a similar prompt. Alternatively, the prompt may presented to the consumer verbally by an employee of the merchant. For example, where the point-of-sale device is manned by a cashier, the prompt may be viewed by the cashier, and the cashier may then ask the consumer whether he/she wishes to join the merchant's membership program.

In response to receiving the prompt at 326, the consumer may provide to the merchant a request to join the merchant's membership program, as illustrated at 328. For example, the consumer may select a “Join” button on a keypad at the point-of-sale device, or may verbally inform the cashier that he/she wishes to join. In the case that the consumer does not wish to join the membership program, the consumer may select, for example, a “Not Now” button, and the transaction may proceed without the consumer joining the membership program.

Where the consumer does provide a request to join at 328, the request contains, at a minimum, the UR number and an indication of the membership program that the consumer wishes to join, for example, the merchant identifier. The request may also contain a join date, a store identifier, and any other information required by the merchant, the merchant's membership system, and the URR system for joining the membership program.

Responsive to receiving the request to join, the merchant sends the request to the URR system, as illustrated at 330. In response to receiving the request to join, as illustrated at 332, the URR system selects a new membership identifier from a pool of membership identifiers allocated to the URR system by the merchant (or by a third party membership system). The URR system then links the selected membership identifier (for the merchant identifier) to the UR number of the consumer, as illustrated at 334. That is, the URR system updates the UR database such that, in future, when the URR system receives a UR receipt containing the particular UR number and the particular merchant identifier in question, the URR system will be able to retrieve the selected membership identifier.

After linking the selected membership identifier (for the merchant identifier) to the UR number of the consumer, the URR system may then send a UR response to the merchant (or to the third party membership system), as illustrated at 336. The response includes the membership identifier which has been newly linked to the UR number. Optionally, the UR response may include other items, such as consumer identity information to be provided to the merchant's membership system. Alternatively, such information might be sent by the URR system to the merchant or to the third party membership system at some later time, for example, in a batch together with the information for other newly joined consumers. The response may be formatted in accordance with the example UR receipt or UR response in Appendix C.

Responsive to receiving the UR response from the URR system, the merchant (or the third party membership system) extracts the membership identifier, as illustrated at 338. Now that the consumer has a membership identifier, the consumer can be recognized by the merchant's membership program. For example, the membership identifier may be used by the membership system to allow the consumer to accrue loyalty points with the current transaction. Optionally, the merchant may present the membership identifier to the consumer, as illustrated at 340. Alternatively or additionally, the merchant may present to the consumer information associated with his/her membership, such as the total number of loyalty points accrued, the number of loyalty points accrued with the current transaction, and the like.

It is contemplated that a consumer who is not yet a member of a particular membership program may use, at a merchant that is affiliated with the particular membership program, a payment device presenting a payment number that is associated with a UR number. Similarly to the example of FIG. 6, the consumer may wish to join the particular membership program while making a transaction at the merchant's point-of-sale device.

Join Membership Program During Transaction Involving Payment Token Presenting Payment Number Associated with UR Number

FIGS. 7-1 and 7-2 illustrate example methods for a consumer, for a merchant, for an acquirer data centre, for a payment processor data centre, for an issuer data centre and for a universal recognition system. The methods illustrated in FIGS. 7-1 and 7-2 are for use with a payment token presenting a payment number associated with a universal recognition number that is not linked to a membership identifier of the merchant's membership program.

The token capture process and the processing of the financial transaction may proceed as described with respect to FIGS. 5-1 and 5-2. That is, at 270, the consumer presents the payment token to the merchant. Using a token capture device, the payment number is captured from the token and provided to a point-of-sale device of the merchant, as illustrated at 272. In accordance with traditional processing of a financial transaction, the merchant's point-of-sale device sends a payment receipt to the merchant's acquirer data centre, as illustrated at 274. At 276, the acquirer data centre receives the payment receipt from the merchant and sends the payment receipt to a payment processor data centre. At 280, the payment processor data centre receives the payment receipt from the acquirer data centre. At 282, the payment processor data centre sends the payment receipt to an issuer data centre, and at 284, the issuer data centre receives the payment receipt from the payment processor data centre.

Turning to FIG. 7-1, and, as described previously with respect to FIG. 5-4, the issuer data centre determines at 286 whether to approve or to deny the transaction. At 288, the issuer data centre sends a payment response back to the payment processor data centre, where the payment response contains an indication of whether the transaction was approved or denied. At 290, the payment processor data centre receives the payment response and sends it to the acquirer data centre. At 292, the acquirer data centre receives the payment response and sends it to the merchant. At 294, the merchant's point-of-sale device receives the payment response, and, in accordance with the contents of the payment response, the merchant may, for example, complete the transaction or may provide the consumer with information regarding why the transaction was denied.

As described previously with respect to FIG. 5-1, in one example, at approximately the same time as the financial transaction is being processed, at 296, the payment processor data centre uses the payment number received from the acquirer data centre at 280 to retrieve the associated UR number from the table of payment numbers and associated UR numbers. From the IIN of the retrieved UR number, the payment processor data centre identifies that a UR receipt should be sent to the URR system. Accordingly, at 298, the payment processor data centre generates and sends a UR receipt to the URR system.

At 300, the URR system receives the UR receipt from the payment processor data centre. However, instead of the URR system retrieving at 302 the membership identifier linked to the UR number for the merchant identified in the UR receipt, the URR system instead determines at 342 that the UR number is not linked to a membership identifier for the merchant identified in the UR receipt. That is, the consumer is not yet a member of the merchant's membership program.

In response to making the determination at 342 that the consumer has not yet joined the merchant's membership program, the URR system sends a prompt to the merchant prompting the consumer to join the merchant's membership program, as illustrated at 344. In one example, the prompt may simply be an error data message, which the merchant will interpret as an indication that the consumer does not have a membership identifier for the merchant's membership program. The prompt may be formatted in accordance with the example UR receipt or UR response in Appendix C.

Responsive to receiving the prompt, the merchant may prompt the consumer to join the merchant's membership program, as illustrated at 346, and as described previously with respect to FIG. 6.

In response to receiving the prompt at 348, the consumer may provide to the merchant a request to join the merchant's membership program, as illustrated at 350 in FIG. 7-2. Where the consumer provides a request to join at 350, the request contains, at a minimum, the UR number and an indication of the membership program that the consumer wishes to join, for example, the merchant identifier. The request may also contain a join date, a store identifier, and any other information required by the merchant, the merchant's membership system, and the URR system for joining the membership program.

Responsive to receiving the request to join, the merchant sends the request to the URR system, as illustrated at 352. In response to receiving the request to join, as illustrated at 354, the URR system selects a new membership identifier from a pool of membership identifiers allocated to the URR system by the merchant (or by a third party membership system). The URR system then links the selected membership identifier (for the merchant identifier) to the UR number of the consumer, as illustrated at 356. That is, the URR system updates the UR database such that, in future, when the URR system receives a UR receipt containing the particular UR number and the particular merchant identifier in question, the URR system will be able to retrieve the selected membership identifier.

After linking the selected membership identifier (for the merchant identifier) to the UR number of the consumer, the URR system may then send a UR response to the merchant (or to the third party membership system), as illustrated at 358. The response includes the membership identifier which has been newly linked to the UR number. The response may be formatted in accordance with the example UR receipt or UR response in Appendix C. Optionally, the UR response may include other items, such as consumer identity information to be provided to the merchant's membership system. Alternatively, such information might be sent by the URR system to the merchant or to the third party membership system at some later time, for example, in a batch together with the information for other newly joined consumers.

Responsive to receiving the UR response from the URR system, the merchant (or the third party membership system) extracts the membership identifier, as illustrated at 360. Now that the consumer has a membership identifier, the consumer can be recognized by the merchant's membership program. For example, the membership identifier may be used by the membership system to allow the consumer to accrue loyalty points with the current transaction. Optionally, the merchant may present the membership identifier to the consumer, as illustrated at 362. Alternatively or additionally, the merchant may present to the consumer information associated with his/her membership, such as the total number of loyalty points accrued, the number of loyalty points accrued with the current transaction, and the like.

Thus far, examples of interactions between the URR system and partnering merchants, partnering payment processors and partnering issuers have been described. However, it is also contemplated that a consumer having a UR account is able to interact with the URR system via an interface to the URR system, herein described as a “UR portal”. A consumer may access his/her UR account, for example, by providing one or more items of consumer identity information, such as a username and a password. The UR portal enables the consumer to update the consumer identity information for the UR account. For example, the consumer may update his/her address via the UR portal. The UR portable also enables the consumer to link an existing membership identifier to an existing UR number in that account, as will be described with respect to FIG. 8. Further, the UR portal enables the consumer to join a membership program offered by a merchant (or a third party membership system) that has partnered with the UR platform provider, thereby linking a newly-issued membership identifier for the merchant (or the third party membership system) to an existing UR number in that account, as will be described with respect to FIG. 9.

In one example, the UR portal is implemented as a website that connects to the URR system. In this implementation, the consumer accesses the interface through a regular web browser. The website, although provided by the UR platform provider, may be branded to appear as though it is provided by another entity. This is known as a “white-label service”. For example, the website may be branded to appear as though it is provided by the issuer of a payment device (e.g. a financial institution), or as though it is provided by a payment processor (e.g. MasterCard® or VISA®), or as though it is provided by a merchant (e.g. a grocery store or a bookstore).

Consumer Management of UR Account: Link Existing Membership Identifier to UR Number

FIG. 8 illustrates example methods for a consumer, for a UR portal, and for a URR system. The methods illustrated in FIG. 8 are for use in linking an existing membership identifier of a merchant's membership program to a UR number of the consumer.

At 364, the consumer may login to UR portal by providing one or more items of consumer identity information to the UR portal, where the consumer identity information is uniquely associated with a single UR account which contains one or more UR numbers. In one example, the consumer enters a username and a password.

Upon logging into the UR portal at 364, the UR portal may optionally present to the consumer a list of one or more merchants that have partnered with the UR platform provider, as illustrated at 366. For example, the UR portal may display a drop-down menu listing the partnering merchants. In another example, the UR portal may list partnering merchants for selection by the consumer. Alternatively, the UR portal may enable the consumer to search for a specific partnering merchant by providing identifying information of the merchant to the UR portal. In one example, the URR system determines for which of the partnering merchants (or third party membership programs) the consumer does not already have a membership identifier linked to a UR number within his/her UR account. These merchants (or membership programs) are then presented to the consumer via the UR portal as candidates for joining or linking

In the event that the consumer is already a member of a merchant's membership program, the consumer may link his/her existing membership identifier with a UR number of the consumer's UR account using the UR portal. For example, from the candidate merchants or membership programs presented to the consumer at 366, the consumer may select a merchant or membership program to which consumer the consumer already belongs, but for which the membership identifier is not yet linked to a UR number in his/her UR account. Upon selecting the merchant or membership program, as illustrated at 368, the consumer provides his/her existing membership identifier to the UR portal.

The consumer then provides a request to link the membership identifier of the selected merchant or membership program to a UR number of the UR account, as illustrated at 370. In the event that multiple UR numbers are associated with the UR account, the consumer may select one of the UR numbers to link to the membership identifier. The request may be formatted in accordance with the example UR receipt or UR response in Appendix C.

At 372, the UR portal receives the link request and provides it to the URR system. Responsive to receiving the link request from the UR portal at 374, the URR system then proceeds at 376 to link the membership identifier, which was provided by the consumer at 368, to the UR number. That is, the URR system updates the consumer's UR account such that, in future, when the URR system receives a UR receipt containing a UR number of the UR account and a merchant identifier of a merchant that is affiliated with the membership program selected by the consumer at 368, the URR system will be able to retrieve the newly linked membership identifier for that merchant's membership program.

Optionally, after the URR system links the membership identifier to the UR number, the UR portal may present a confirmation to the consumer that the membership identifier has been linked to the UR number, as illustrated at 378.

Although described as a process for linking a UR number to an existing membership identifier for a single merchant or membership program, the user interface of the UR portal may enable selection of multiple merchants or membership programs and provision of multiple corresponding existing membership identifiers, so that the existing membership identifiers are linked to the UR number responsive to a single request from the consumer.

Just as the UR portal enables a consumer to link an existing membership identifier to a UR number, the UR portal also enables the consumer to join membership program of which the consumer is not yet a member.

Consumer management of UR account: join membership program of merchant, link newly assigned membership identifier to UR number

FIG. 9 illustrates example methods for a consumer, for a UR portal, and for a URR system. The methods illustrated in FIG. 9 are for use in joining a merchant's membership program and linking a membership identifier of the program to a UR number of the consumer.

As described with respect to FIG. 8, at 364, the consumer logs into the UR portal by providing one or more items of consumer identity information. Responsive to receiving the consumer identity information, the UR portal presents candidate merchants (or membership programs) to the consumer, as illustrated at 366.

In the event that the consumer does not yet belong to a particular membership program of a merchant that is partnered with the UR platform provider, the consumer may select the particular membership program, as illustrated at 380, and provides to the UR portal a request to join the selected membership program, as illustrated at 382. In the event that multiple UR numbers are associated with the UR account, the consumer may select one of the UR numbers to link to the membership identifier. The request may be formatted in accordance with the example UR receipt or UR response in Appendix C.

At 384, the UR portal receives the request to join the selected membership program from the consumer and provides the request to the URR system. After receiving the request to join from the UR portal at 386, the URR system selects a new membership identifier from a pool of membership identifiers allocated to the URR system by the merchant (or by the third party membership system), as illustrated at 388. The UR portal may optionally present the selected membership identifier to the consumer, as illustrated at 390.

The URR system links the selected membership identifier to the UR number of the consumer, as illustrated at 392. That is, the URR system updates the consumer's UR account such that, in future, when the URR system receives a UR receipt containing a UR number of the UR account and a merchant identifier of the merchant that is affiliated with the membership program selected by the consumer at 380, the URR system will be able to retrieve the membership identifier for the membership program which the consumer has just joined.

Optionally, after the URR system links the membership identifier to the UR number, the UR portal may present a confirmation to the consumer that the membership identifier has been linked to the UR number, as illustrated at 394.

Although not illustrated, after linking the membership identifier to the UR number at 392, the URR system provides an update to the merchant (or the third party membership system). For example, URR system may inform that merchant (or the third party membership system) that the membership identifier has been assigned to a consumer, and may provide the merchant (or the third party membership system) with any items of consumer identity information that are requested. This updating may be performed upon joining, or may be performed at some time later, for example, in a batch together with information for other newly joined consumers.

UR Platform

FIG. 10 illustrates a schematic diagram of an example UR platform, generally referenced 400. As mentioned above, the UR platform is a collection of capabilities and applications serving an eco-system. The eco-system comprises the provider of the UR platform, participating merchants, consumers wishing to be recognized by the participating merchants, any third-party operators of membership systems affiliated with some of the participating merchants, and multiple payment transaction partners (acquirers and/or payment processors and/or issuers).

Certain elements of the example UR platform 400, including the URR system 2, are implemented at the UR platform provider. Other elements are located at the participating merchants, and still other elements are implemented at the payment transaction partner data centres.

At point-of-sale devices 401 of participating merchants 403, the IIN range tables are arranged so that the point-of-sale devices 401 direct communications associated with UR numbers to the URR system 2. This arrangement of the IIN range table at the point-of-sale devices 401, and any logic and commands implemented at the point-of-sale device 401 for handling the UR number, is represented schematically as circle 20. Accordingly, the point-of-sale devices 401 are able to generate UR receipts and to send the generated UR receipts to the URR system 2, where each UR receipt contains, at a minimum, a UR number captured from a token and an indication of the membership program for which a membership identifier is needed, for example, a merchant identifier.

A point-of-sale device 401 is similar to a traditional point-of-sale device in that it (and additional point-of-sale devices 401) may be connected to an internal network (not shown) of the participating merchant 403. A point-of-sale device 401 is similar to a traditional point-of-sale device in that it may be able to accept payment numbers, to generate payment receipts, to send the payment receipts via payment communication networks, and to receive corresponding payment responses via the payment communication networks.

However, a point-of-sale device 401 may differ from a traditional point-of-sale device in at least the following respects. A traditional point-of-sale device may reject or ignore a UR number that begins with an IIN number that identifies the UR platform 400, where the UR number is received by the traditional point-of-sale device from a token capture device coupled to or incorporated in the point-of-sale device, because the IIN range table at the traditional point-of-sale device does not include that IIN number and the traditional point-of-sale device is not configured to process or handle the UR number in any way. In contrast, the IIN range table at the point-of-sale device 401 includes the IIN number that identifies the UR platform 400, and the point-of-sale device 401 is configured (via the logic and commands) to generate a UR receipt and to send the UR receipt to an IP address of the URR system 2. A traditional point-of-sale device has no way to communicate with the URR system 2. In contrast, the point-of-sale device 401 is connected to a further communication network that is not part of any payment communication network and via which the point-of-sale device 401 can send the UR receipt to an IP address of the URR system 2.

Payment transaction partner data centres 402, 404 (payment processor data centres or issuer data centres or acquirer data centres) maintain tables 406, 408, respectively, of payment numbers that are associated to UR numbers. Each payment number in the table 406 is associated with a single UR number in the table 406. For example, in the event that the payment transaction partner data centre 402 is a payment processor data centre, each payment number in the table 406 is a payment number carrying a brand of the payment processor data centre. For example, in the event that the payment transaction partner data centre 404 is an issuer data centre, each payment number in the table 408 is a payment number issued by the issuer data centre. Logic and commands (not shown) are implemented at the payment transaction partner data centres, so that the payment transaction partner data centres are able to retrieve from their respective tables a UR number associated with a payment number, to generate a UR receipt containing, at a minimum, the retrieved UR number and an indication of the membership program for which a membership identifier is needed, for example, a merchant identifier, and to send the UR receipt to the URR system 2.

The URR system 2, comprising the database 4, the one or more communication interfaces 6, and the switching subsystem 8, may be implemented partly in hardware and partly in software.

The database 4 comprises a linked UR number registry 410 which tracks linked UR numbers and the membership identifiers to which they are linked. For a given linked UR number, the linked UR number registry 410 may store information that pertains to the UR number and information that pertains to membership identifiers that are linked to the UR number. The information that pertains to the UR number includes the UR number itself, and may also include, for example, an issue date of the UR number to the consumer, an activation date of the UR number, a status of the UR number (e.g., issued, active, or lost), and a token type of the UR number (that is, the type of token, if any, that presents the UR number, e.g. a magstripe card, a smartcard, an e-wallet, etc.). The information that pertains to membership identifiers that are linked to the UR number includes, for a given linked membership identifier linked to the UR number: a merchant identifier or a merchant name or both, a linked membership identifier for a membership program of the merchant, and may also include, for example, an issue date of the membership identifier, an activation date of the membership identifier, a status of the membership identifier (e.g., issued, active or lost), and a token type of the membership identifier (that is, the type of token, if any, that presents the membership identifier, e.g. a magstripe card, a smartcard, an e-wallet, etc.). For the given linked UR number, the linked UR number registry 410 may also store an opt in/opt out indicator, an opt out date, an opt out reason, and the like.

The database 4 further comprises, for each third-party membership program affiliated with multiple merchants, a registry 412 of merchant information (merchant identifier or merchant name or both) for those merchants affiliated with the third-party membership program and associates with the registry 412 an identifier of the third-party membership program.

Additional data stored and used by the UR platform provider may be stored in a database 414. Such data may include, for example, a consumer identity information registry 416, a UR number allocation registry 418, an entity rules registry 420, and a transactional data registry 422.

The data maintained in the database 4 and in the database 414 is described in this document in terms of data registries. However, it will be understood by a person skilled in the art that the database 4, the database 414 and the data registries comprised therein are merely examples, and that there exist many different ways of storing and handling such data.

The consumer identity information registry 416 stores identity information of consumers having UR accounts within the UR platform 400. For a given consumer, the consumer identity information registry 416 may store, for example, first name, last name, date of birth, age, gender, ethnicity, salary range, date of joining the UR system, residential address, mailing address, email address, phone number, fax number, verification question, verification answer, language preference, opt-out indicator, opt-out reason, and the like.

The UR number allocation registry 418 tracks the allocation of UR numbers to partnering entities, such as merchants, membership systems, payment processors and issuers. For a given partnering entity, the UR number allocation registry 418 may store, for example, an entity identifier (e.g. merchant identifier), the entity name, the range of UR numbers allocated to that entity (indicated, for example, by a starting UR number and an ending UR number), a date that the range of UR numbers was allocated to the entity, the entity type (e.g. issuer, payment processor, merchant, third party membership system), the UR number that was most recently issued by the entity to any consumer, a count of the active UR numbers that have been issued by the entity to consumers, a count of the UR numbers that have been issued by the entity to consumers but are not active, a count of the UR numbers remaining to be issued within the UR range allocated to the entity, and the like.

The entity rules registry 420 stores rules associated with the partnerships between various entities and the UR platform provider. For a given entity, the registry 420 may store, for example, an entity identifier (e.g. a merchant identifier), an entity name, a corporate address of the entity, a billing address of the entity, an entity type (e.g. issuer, payment processor, acquirer, merchant, third party membership system), entity rules (such as how and when to reconcile, how and when the UR system is to seek payment from the entity, where the UR system is to send a UR response containing a retrieved membership identifier), and the like.

The transactional data registry 422 stores information associated with transactions, where such information may be used for reconciliation, dispute purposes, audit purposes, marketing purposes, and the like. For a given transaction, the transactional data registry 422 may store, for example, a UR number, an amount of a transaction, or settlement between the UR platform provider and a merchant or payment transaction partner, a transmission date and time, a systems trace audit number, a time of local transaction between the UR platform provider and a merchant or payment transaction partner, a date of local transaction, a merchant identifier, a merchant type (e.g. restaurant, general merchandise, gas station, etc.), a POS entry mode, a POS condition code, an acquiring institution ID code, a forwarding institution ID code, a retrieval reference number, an authorization ID response, a response code, a card acceptor terminal ID, a card acceptor ID code, a card acceptor name/location, and the like.

The switching subsystem 8 may enable the URR system 2 to perform its role in any of the methods described with respect to FIGS. 1-9.

In one example, the switching subsystem 8 handles a UR receipt that is received, via one of the communication interfaces 6, from a merchant or from a payment transaction partner data centre, as follows: the switching subsystem 8 causes the URR system 2 to retrieve from the database 4 the membership identifier that is linked to the UR number in the UR receipt (where the membership identifier is for a membership program of the merchant identified in the receipt), and causes the URR system 2 to generate a UR response containing the membership identifier, and to send, via one of the communication interfaces 6, the UR response to the merchant or to the merchant's membership system (in accordance with rules in the entity rules registry 420). That is, the switching subsystem 8 causes the URR system 2 to perform any of the steps 260, 262 and 264 in FIG. 4, and any of the steps 300, 314, 319, 302 and 304 in FIGS. 5-1, 5-2, 5-3 and 5-4.

In another example, the switching subsystem 8 handles a UR receipt that is received, via one of the communication interfaces 6, from a merchant or from a payment transaction partner data centre, as follows: the switching subsystem 8 causes the URR system 2 to send, via one of the communication interfaces 6, a prompt to the merchant prompting the consumer to join the merchant's membership program, and, responsive to receiving an request to join via one of the communication interfaces 6, causes the URR system 2 to select a membership identifier for the merchant identified in the receipt, to link the membership identifier to the UR number that was in the UR receipt (by updating the linked UR number registry 410), and to generate a UR response containing the membership identifier, and to send, via one of the communication interfaces 6, the UR response to the merchant or to the merchant's membership system. That is, the switching subsystem 8 causes the URR system 400 to perform any of the steps 260, 320, 322, 332, 334 and 336 in FIG. 6, and any of the steps 342, 344, 354, 356 and 358 in FIGS. 7-1 and 7-2.

In a further example, the switching subsystem 8 may handle a link request received from a UR portal via one of the communication interfaces 6, where the link request is requesting the linking of an existing membership identifier to a UR number. The switching subsystem 8 handles the link request by causing the URR system 2 to update the linked UR number registry 410 with information that pertains to the existing membership identifier, such as the membership identifier, and a merchant identifier or a merchant name or both. That is, the switching subsystem 8 may cause the URR system 2 to perform any of the steps 374 and 376 in FIG. 8.

In yet another example, the switching subsystem 8 may handle a request to join received from a UR portal via one of the communication interfaces 6, where the request to join is requesting that a consumer join a merchant's membership program of which he/she is not yet a member. The switching subsystem 8 handles the request to join by causing the URR system 2 to select a membership identifier for the merchant identified in the request to join and to link the membership identifier to a UR number of the consumer by updating the linked UR number registry 410. That is, the switching subsystem 8 may cause the UR system 2 to perform any of the steps 386, 388 and 392 in FIG. 9.

A management subsystem 426, which is coupled to the UR system 2 and to the database 414, is operative to handle other activities, such as the provisioning of allocated UR numbers to partnering entities, requests to retrieve consumer identity information, requests to update consumer identity information, and the like. The management subsystem 426 may be implemented partly in hardware and partly in software.

A UR portal subsystem 428, which is coupled to the UR system 2 and to the database 414, is operative to provide the UR portal to consumers and to perform any of the steps 364, 366, 372, and 378 in FIG. 8 and any of the steps 364, 366, 384, 390, and 394 in FIG. 9. The UR portal subsystem 428 may also enable consumers to update their consumer identity information. The updated consumer identity information may be shared with the various membership programs. The UR portal subsystem 428 may be implemented partly in hardware and partly in software, and may include a web server.

Throughout this document, payment numbers have been described as being associated with UR numbers, and payment transaction partner data centres have maintained a table of payment numbers and associated UR numbers in order to retrieve a UR number associated with a payment number and to send the retrieved UR number to the URR system. It is contemplated that a particular issuer (or all issuers working with a particular payment processor) may use UR numbers as the payment numbers. For example, the UR platform provider may allocate a pool of UR numbers to the particular issuer (or to the particular payment processor). A UR number from the allocated pool (“payment UR number”) can then be used as a payment number for a consumer when the consumer opens an account, and the consumer may be issued a payment token having that payment UR number. Presentation of the payment token having the payment UR number at a merchant to effect payment in a financial transaction will cause the merchant's point-of-sale device to treat the payment UR number as any other acceptable payment number. When the payment receipt generated by the point-of-sale device reaches the particular payment processor data centre, the payment processor data centre will generate a UR receipt that includes, at a minimum, the payment UR number and an indication of the membership program for which a membership identifier is needed, for example, a merchant identifier, as described above with respect to FIGS. 2-1, 2-2, 2-3, 2-4, 2-5, and 5-1, 5-2, 5-3, and 5-4, albeit without use of a table such as the table 66, the table 116, or the table 146. This contemplated scenario is illustrated in FIG. 3 by the inclusion in the UR account 200 of a UR number V 209 which is identical to a payment number V 209. The UR number V 209 is automatically linked to any and all other UR numbers in the UR account 200, as illustrated conceptually by lines 252.

The present teachings describe a distributed network of computing devices which are configured relative to one another to allow the use of a common data identifier (universal recognition number) uniquely associated with a user (consumer) in a variety of different arrangements. The common data identifier (universal recognition number) may also be uniquely associated with a payment number that itself is uniquely associated with the user (consumer). The common data identifier (universal recognition number) is linked at a computing system (URR system) to one or more different non-related other data identifiers (membership identifiers).

The present teaching provides and uses non-traditional communication channels between, for example, point-of-sale devices and the computing system (URR system), and between, for example, the computing system (URR system) and computing devices of the merchant or of a membership system that operates a membership program. This new architecture enables the merchants to accept and make use of the common data identifier, and facilitates and enables the provision of additional functionality and services to a user (consumer).

The present teaching provides and uses non-traditional communication channels between, for example, acquirer data centres, payment processor data centres, and issuer data centres, and the computing system (URR system). This new architecture facilitates and enables the provision of additional functionality and services to a user (consumer).

The technology described herein may be adapted for use in the context of government services. An individual may use a token to present a unique number in order to be recognized, not as a member of membership program, but as an individual seeking to receive services from a governmental organization or agency.

The technology described herein may be adapted for use in the context of transit. An individual may use a token to present a unique number in order to be recognized, not as a member of membership program, but as an individual seeking to receive services from or to gain access to a transit organization.

In these adaptations, the unique number may be presented at a point of presentation, and may comply with an industry standard, for example, universal resource locator (URL), universal price code (UPC), international standard book number (ISBN).

The scope of the claims should not be limited by the specific implementation set forth in the examples, but should be given the broadest interpretation consistent with the description as a whole.

APPENDIX A
UR receipt and UR response formatted in accordance with
ISO 0600/0601 and 0610 administrative data messages

| | | | 0610 |
|---|---|---|---|
| Bit | Description | 0600/0601 Receipt | Response |
| 2 | Primary account number | Conditional | |
| 3 | Processing code | Always sent | Optional |
| 7 | Transmission date and time | Always sent | |
| 11 | Systems trace audit number | Always sent | |
| 12 | Time, local transaction | Always sent | |
| 13 | Date, local transaction | Always sent | |
| 14 | Date, expiration | Optional | |
| 18 | Merchant's type | Conditional | |
| 22 | POS entry mode | Always sent | |
| 23 | Card sequence number | Conditional | |
| 25 | POS condition code | Always sent | |
| 26 | POS PIN capture code | Conditional | |
| 32 | Acquiring institution ID code | Conditional | |
| 35 | Track 2 data | Conditional | |
| 37 | Retrieval reference number | Always sent | |
| 39 | Response code | | Mandatory |
| 40 | Service restriction code | Conditional | |
| 41 | Card acceptor terminal ID | Always sent | |
| 42 | Card acceptor ID code | Always sent | |
| 43 | Card acceptor name/location | Always sent | |
| 44 | Additional Response Data | | |
| 48 | UR number | Mandatory | Optional |
| 52 | PIN data | Conditional | |
| 53 | CVV2 | Conditional | |
| 55 | ICC Data | Conditional | |
| 56 | Data message reason code | Always sent | |
| 59 | Echo data | Always sent | Always sent |
| 62 | Network ID | Conditional | Conditional |
| 122 | Additional Data | | |
| 123 | POS data code | Always sent | |
| 126 | Key data | Conditional | Optional |
| 127 | Membership ID | | Always sent |
| 128 | MAC Extended | Conditional | Conditional |

APPENDIX B
payment receipt and payment response formatted in accordance
with ISO 0100 and ISO 0110 administrative data messages

| | | | 0110 |
|---|---|---|---|
| Bit | Description | 0100 Receipt | Response |
| 2 | Primary account number | Optional - | Optional - |
| | | PCI | PCI |
| 3 | Processing code | If Required | If Required |
| 4 | Amount, transaction | Mandatory | Always Sent |
| 5 | Amount, settlement | Conditional | Conditional |
| 7 | Transmission date and time | Always sent | Always sent |
| 9 | Conversion rate, settlement | Conditional | Conditional |
| 11 | Systems trace audit number | Always sent | Always sent |
| 12 | Time, local transaction | Always sent | |
| 13 | Date, local transaction | Always sent | |
| 14 | Date, expiration | Conditional | |
| 15 | Date, settlement | Always sent | |
| 16 | Date conversion | Conditional | Conditional |
| 18 | Merchant's type | Conditional | |
| 22 | POS entry mode | Always sent | |
| 23 | Card sequence number | Conditional | |
| 25 | POS condition code | Always sent | |
| 26 | POS PIN capture code | Conditional | |
| 27 | Authorization ID response length | Conditional | |
| 28 | Amount, transaction fee | Always sent | Always sent |
| 29 | Amount, settlement fee | Optional | Optional |
| 30 | Amount, transaction processing fee | Optional | Optional |
| 31 | Amount, settle processing fee | Optional | Optional |
| 32 | Acquiring institution ID code | Always sent | |
| 33 | Forwarding institution ID code | Conditional | |
| 35 | Track 2 data | Always sent | |
| 37 | Retrieval reference number | Always sent | Always sent |
| 38 | Authorization ID response | | Conditional |
| 39 | Response code | | Always sent |
| 40 | Service restriction code | Conditional | |
| 41 | Card acceptor terminal ID | Always sent | |
| 42 | Card acceptor ID code | Always sent | |
| 43 | Card acceptor name/location | Always sent | |
| 44 | Additional response data | | Optional |
| 48 | Account information | | |
| 49 | Currency code, transaction | Always sent | |
| 50 | Currency code, settlement | Conditional | Conditional |
| 52 | PIN data | Conditional | |
| 53 | CVV2 | Conditional | Optional |
| 54 | Additional amounts | Conditional | Conditional |
| 55 | ICC Data | If EMV | If EMV |
| 56 | Data message reason code | Always sent | |
| 57 | Authorization life cycle | Conditional | |
| 58 | Authorizing agent ID code | | Conditional |
| 59 | Echo data | Always sent | Always sent |
| 61 | Extended address | Optional | |
| 62 | Network ID | Conditional | Conditional |
| 63 | Extended tran type | Optional | |
| 123 | POS data code | Always sent | |
| 126 | Key data | Conditional | Conditional |
| 127 | Structured data | | |
| 128 | MAC extended | Conditional | Conditional |

APPENDIX C
UR receipt and UR response formatted in accordance with
ISO 0100 and ISO 0110 administrative data messages

| | | | 0110 |
|---|---|---|---|
| Bit | Description | 0100 Receipt | Response |
| 2 | Primary account number | Optional - | Optional - |
| | | PCI | PCI |
| 3 | Processing code | If Required | If Required |
| 4 | Amount, transaction | Mandatory | Always Sent |
| 5 | Amount, settlement | Conditional | Conditional |
| 7 | Transmission date and time | Always sent | Always sent |
| 9 | Conversion rate, settlement | Conditional | Conditional |
| 11 | Systems trace audit number | Always sent | Always sent |
| 12 | Time, local transaction | Always sent | |
| 13 | Date, local transaction | Always sent | |
| 14 | Date, expiration | Conditional | |
| 15 | Date, settlement | Always sent | |
| 16 | Date conversion | Conditional | Conditional |
| 18 | Merchant's type | Conditional | |
| 22 | POS entry mode | Always sent | |
| 23 | Card sequence number | Conditional | |
| 25 | POS condition code | Always sent | |
| 26 | POS PIN capture code | Conditional | |
| 27 | Authorization ID response length | Conditional | |
| 28 | Amount, transaction fee | Always sent | Always sent |
| 29 | Amount, settlement fee | Optional | Optional |
| 30 | Amount, transaction processing fee | Optional | Optional |
| 31 | Amount, settle processing fee | Optional | Optional |
| 32 | Acquiring institution ID code | Always sent | |
| 33 | Forwarding institution ID code | Conditional | |
| 35 | Track 2 data | Always sent | |
| 37 | Retrieval reference number | Always sent | Always sent |
| 38 | Authorization ID response | | Conditional |
| 39 | Response code | | Always sent |
| 40 | Service restriction code | Conditional | |
| 41 | Card acceptor terminal ID | Always sent | |
| 42 | Card acceptor ID code | Always sent | |
| 43 | Card acceptor name/location | Always sent | |
| 44 | Additional response data | | Optional |
| 48 | UR number | Mandatory | Conditional |
| 49 | Currency code, transaction | Always sent | |
| 50 | Currency code, settlement | Conditional | Conditional |
| 52 | PIN data | Conditional | |
| 53 | CVV2 | Conditional | Optional |
| 54 | Additional amounts | Conditional | Conditional |
| 55 | ICC Data | If EMV | If EMV |
| 56 | Data message reason code | Always sent | |
| 57 | Authorization life cycle | Conditional | |
| 58 | Authorizing agent ID code | | Conditional |
| 59 | Echo data | Always sent | Always sent |
| 61 | Extended address | Optional | |
| 62 | Network ID | Conditional | Conditional |
| 63 | Extended tran type | Optional | |
| 123 | POS data code | Always sent | |
| 126 | Key data | Conditional | Conditional |
| 127 | Membership ID | Conditional | Mandatory |
| 128 | MAC extended | Conditional | Conditional |

What is claimed is:

1. A computer-implemented universal recognition and routing system comprising:
a database storing a universal recognition number that begins with a particular Issuer Identification Number (IIN) and storing, linked to the universal recognition number, a membership identifier that identifies a particular consumer in a particular membership program;
a communication interface via which data messages can be received and sent; and
a switching subsystem coupled to the database, wherein, responsive to receiving via the communication interface a receipt data message that includes, at a minimum, the universal recognition number and an indication of the particular membership program, the switching subsystem is operative:
to retrieve the membership identifier from the database;
to generate a response data message that includes, at a minimum, the membership identifier retrieved from the database; and
to send the response data message, via the communication interface, to a merchant or to a membership system operating the particular membership program.

2. The universal recognition and routing system as recited in claim 1, wherein the communication interface is operative to receive and to send data messages via communication networks that are not part of any payment communication network.

3. A point-of-sale device at a merchant, the point-of-sale device storing an Issuer Identification Number (IIN) table that includes an entry with a particular IIN, the point-of-sale device operative:
to identify, by consulting the IIN table, that a universal recognition number captured by a token capture device begins with the particular IIN, wherein the token capture device is either coupled to or incorporated in the point-of-sale device; and
responsive to identifying that the universal recognition number captured by the token capture device begins with the particular IIN, to generate a receipt data message, and to send the receipt data message to an Internet Protocol ‘IP’ address of a universal recognition and routing system,
wherein the receipt data message includes, at a minimum, the universal recognition number and an indication of a particular membership program.

4. The point-of-sale device as recited in claim 3, wherein the point-of-sale device is operative to send the receipt data message via a communication network that is not part of any payment communication network.

5. A payment transaction partner data centre storing a table that associates universal recognition numbers that begin with a particular Issuer Identification Number (IIN) to payment numbers, wherein, responsive to receiving a payment receipt via a payment communication network as part of processing a financial transaction, the payment receipt including an identifier of a merchant at which the financial transaction is conducted and a payment number presented to effect payment of the financial transaction, the payment transaction partner data centre is operative:
to retrieve the universal recognition number associated with the payment number from the table;
to generate a receipt data message; and
to send the receipt data message to an Internet Protocol (IP) address of a universal recognition and routing system,
wherein the receipt data message includes, at a minimum, the universal recognition number and the identifier of the merchant, and
wherein the universal recognition number is not identical to the payment number.

6. The payment transaction partner data centre as recited in claim 5, wherein the payment transaction partner data centre is operative to send the receipt data message via a communication network that is not part of any payment communication network.

7. The payment transaction partner data centre as recited in claim 5, wherein the payment transaction partner data centre is a payment processor data centre.

8. The payment transaction partner data centre as recited in claim 5, wherein the payment transaction partner data centre is an issuer data centre.

9. The payment transaction partner data centre as recited in claim 5, wherein the payment transaction partner data centre is an acquirer data centre.

10. A computer-implemented method for recognition of a consumer who is identified in a particular membership program by a membership identifier, the method comprising:
in real time, during a transaction at a merchant:
capturing, using a token capture device, a universal recognition number from a non-payment token presented at the merchant, the universal recognition number beginning with a particular Issuer Identifier Number (IIN); and
at a point-of-sale device of the merchant, the point-of-sale device storing an IIN table that includes an entry with the particular IIN, identifying that the universal recognition number captured by the token capture device begins with the particular IIN, and consequently generating a receipt data message and sending the receipt data message to an Internet Protocol (IP) address of a universal recognition and routing system,
wherein the token capture device is either coupled to or incorporated in the point-of-sale device, and
the receipt data message includes, at a minimum, the universal recognition number and an indication of the particular membership program; and
subsequent to sending the receipt data message:
receiving from the universal recognition and routing system, at the merchant or at a membership system operating the particular membership program, a response data message that includes the membership identifier;
extracting the membership identifier from the response data message; and
using the membership identifier for recognition of the consumer within the particular membership program in connection with the transaction.

11. The method as recited in claim 10, wherein receiving the response data message, extracting the membership identifier, and using the membership identifier for recognition of the consumer occur in real time during the transaction.

12. The method as recited in claim 10, wherein the transaction is not a financial transaction.

13. A computer-implemented method to facilitate recognition of consumers, the method comprising:
receiving at a communication interface, via a communication network that is not part of any payment communication network, a receipt data message that includes an indication of a particular membership program and a universal recognition number that begins with a particular Issuer Identification Number (IIN), the receipt data message having been generated at a point-of-sale device during a transaction by a particular consumer at a merchant;
retrieving from a database a membership identifier that is linked in the database to the universal recognition number, the membership identifier identifying the particular consumer in the particular membership program;
generating a response data message that includes the membership identifier retrieved from the database; and
routing the response data message, via a communication network that is not part of any payment communication network, to the merchant or to a membership system operating the particular membership program, for use by the merchant or by the membership system in recognition of the particular consumer in connection with the transaction.

14. A computer-implemented method to facilitate recognition of consumers, the method comprising:
in real time during a financial transaction by a particular consumer at a merchant:
receiving, via a payment communication network, a payment receipt as part of the processing of the financial transaction, the payment receipt including a payment number and an identifier of the merchant;
retrieving from a table a universal recognition number that is associated in the table to the payment number, wherein the universal recognition number begins with a particular Issuer Identification Number (IIN);
generating an receipt data message; and
sending the receipt data message, via a communication network that is not part of any payment communication network, to an Internet Protocol (IP) address of a universal recognition and routing system,
wherein the receipt data message includes, at a minimum, the universal recognition number and the identifier of the merchant, and
wherein the universal recognition number is not identical to the payment number.

15. The method as recited in claim 14, performed by a payment processor data centre.

16. The method as recited in claim 14, performed by an issuer data centre.

17. The method as recited in claim 14, performed by an acquirer data centre.

18. A computer-implemented method to facilitate recognition of consumers, the method comprising:
receiving at a communication interface, via a communication network that is not part of any payment communication network, a receipt data message that includes an indication of a particular membership program and a universal recognition number that begins with a particular Issuer Identification Number (IIN), the receipt data message having been generated by a payment transaction partner data centre during a financial transaction by a particular consumer at a merchant;
retrieving from a database a membership identifier that is linked in the database to the universal recognition number, the membership identifier identifying the particular consumer in the particular membership program;
generating a response data message that includes the membership identifier retrieved from the database; and
sending the response data message, via another communication network that is not part of any payment communication network, to the merchant or to a membership system operating the particular membership program, for use by the merchant or by the membership system in recognition of the particular consumer in connection with the financial transaction.

19. A computer-implemented method to facilitate recognition of consumers, the method comprising:
receiving at a communication interface, via a communication network that is not part of any payment communication network, a receipt data message that includes an indication of a particular membership program and a universal recognition number that begins with a particular Issuer Identification Number (IIN), the receipt data message having been generated by a payment transaction partner data centre during a financial transaction by a particular consumer at a merchant;
retrieving from a database a membership identifier that is linked in the database to the universal recognition number, the membership identifier identifying the particular consumer in the particular membership program;
generating a response data message that includes the membership identifier retrieved from the database; and
sending the response data message, via the communication network that is not part of any payment communication network, to the payment transaction partner data centre, for further communication, together with a payment response for the financial transaction, via payment communication networks to the merchant, for use by the merchant in recognition of the particular consumer in connection with the financial transaction.

20. The method as recited in claim 19, wherein the payment transaction partner data centre is a payment processor data centre.
